(19) United States
(12) Patent Application Publication
(10) Pub. No.: US 2020/0220881 A1
(43) Pub. Date: Jul. 9, 2020

(54) WEIGHTED VERIFICATION OF ENTITY DATA BLOCKS ON A BLOCKCHAIN

(71) Applicant: eBay Inc., San Jose, CA (US)

(72) Inventors: Ashwin Ganesh KRISHNAMURTHY, Campbell, CA (US); Avishek GYAN CHAND, San Jose, CA (US); Preeti Patil ANADURE, Fremont, CA (US); Mukul ARORA, Santa Clara, CA (US)

(21) Appl. No.: 16/243,963

(22) Filed: Jan. 9, 2019

(51) Int. Cl. H04L 29/06; H04L 9/32

(52) U.S. Cl. CPC H04L 63/12; H04L 2209/56; H04L 2209/38; H04L 9/3239

(57) ABSTRACT

Technologies are shown for validating data on a blockchain by a cluster of verification nodes, where nodes vote to verify a new data block with a corresponding class of service. The entity data block is submitted to the cluster for voting, where each node has an associated class of service. Votes received are weighted based on a relationship between the entity data block class of service and the verification node class of service to obtain a weighted vote. A verification score is calculated based on the weighted votes and checked against a verification threshold. If the verification score exceeds the verification threshold, the entity data block is verified on the blockchain. Also, a cluster can use weighted voting to accept a new node where votes are weighted based on a relationship between the new node's class of service and a voting node's class of service.

### BACKGROUND

Generally, it is useful for decision makers to have ready access to information that can be relied upon. For example, information in the context of a resume, online profile or curriculum vitae that has been verified. Typically, many different types of information may be utilized in decision making. By way of example, for hiring or admission decisions, information such as academic history, work history, service history, skill development, or project history may be utilized. The introduction of false or misleading information will degrade a decision based upon that information. It is also beneficial to have reliable information be widely accessible by parties that wish to utilize the information in their decision making process.

One approach to maintaining reliable information in a manner that is widely accessible is to store the information in an entity data block on a blockchain. Currently, the data in each data block is generally verified by one or more verification nodes to ensure its reliability.

It is with respect to these and other considerations that the disclosure made herein is presented.

### SUMMARY

Technologies are disclosed herein for securely validating information data blocks stored on a blockchain by a vote of a group of verification nodes. In certain aspects of the disclosed technology, the vote of each individual verification node is weighted based on a relationship between a class of service of the verification and a class of service of an entity data block being verified. For instance, when an entity data block with a class of service related to education is being verified, a higher weight can be assigned to votes from verification nodes with a class of service related to education than votes from verification nodes with a class of service related to employment. A verification score for an entity data block is calculated based on the weighted votes of the verification nodes and, if the verification score exceeds a threshold, the entity data block is verified for addition to the blockchain. Notably, although education and qualifications are used as exemplary items to be stored in the blockchain, the voting and verification technology described herein may be used in conjunction with any data to be stored in a blockchain.

In another aspect of the disclosed technology, additional verification nodes can be added to the group of verification nodes by vote of the group of verification nodes. A new verification node is submitted for addition to the group of verification nodes. The group of verification nodes votes to accept or deny the new verification node. The vote of each individual verification node is weighted based on a relationship between a class of service of the verification node and a class of service of the new verification node being voted upon. For instance, when a new verification with a class of service related to government is being verified, a higher weight can be assigned to votes from verification nodes with a class of service related to government than votes from verification nodes with a class of service related to service organizations. A verification acceptance score is calculated based on weighted verification votes received and the new verification node is accepted to the group of verification nodes if the acceptance score exceeds a threshold.

An entity data blockchain can be established by an entity or on behalf of an entity to which the data relates, such as an individual, institution, organization or company and data blocks with information relating to the entity can be linked to the entity data blockchain. For example, information regarding education history, work history, and service history events can be stored on a blockchain for an individual. Alternatively, data blocks containing such information can be generated and linked to an existing blockchain, such as the ETHEREUM blockchain. An entity blockchain with credentials allows such uses as verification of qualifications of service providers, staff, of manufacturers of goods, or other similar uses. Accordingly, by verification of service providers, it may also be tied to goods for sales (or blockchains storing goods for sales), to further inform the provenance and integrity of goods.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings. This Summary is provided to introduce a selection of concepts in a simplified form that are further described below in the Detailed Description.

This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 is an architectural diagram showing an illustrative example of a system for an entity data blockchain with a cluster of verification nodes for verification of data blocks on the blockchain;

FIG. 2A is a data architecture diagram showing an illustrative example of an entity data blockchain securing data in data blocks on the blockchain;

FIG. 2B is a data architecture diagram showing another illustrative example of an entity data blockchain where each block on the blockchain stores data relating to a data event pertaining to an entity;

FIG. 3A is a data architecture diagram showing an illustrative example of source entities creating data blocks for data events pertaining to an entity;

FIG. 3B is a data architecture diagram showing an illustrative example of an entity data block on an entity data blockchain that includes code for methods for validating the entity data block;

FIG. 3C is a data architecture diagram showing an illustrative example of verification nodes voting on acceptance of a candidate node;

FIG. 3D is a data architecture diagram showing an illustrative example of verification node data for a cluster of verification nodes that verify data blocks on an entity data blockchain that includes code for methods for voting on acceptance of a new candidate node for the cluster;

FIG. 4A is a control flow diagram showing an illustrative example of a process for creating an entity data block on an entity data blockchain for storing data pertaining to an entity;

FIG. 4B is a control flow diagram showing an illustrative example of a process for determining a weighted vote value for a verification node for validating an entity data block on an entity data blockchain;

FIG. 4C is a control flow diagram illustrating an example of a process for voting on acceptance of a candidate node to a cluster of verification nodes for validating an entity data block on an entity data blockchain;

FIG. 4D is a control flow diagram showing an illustrative example of a process for determining a weighted vote value for a verification node for accepting a a candidate node to a cluster of verification nodes for validating data blocks on an entity data blockchain;

FIG. 4E is a control flow diagram illustrating an example of a verification process for blocks added to the entity data blockchain distributed to untrusted nodes;

FIG. 5 is a data architecture diagram showing an illustrative example of a user using an application programming interface to access data on an entity data blockchain;

FIG. 6A is a data architecture diagram illustrating a simplified example of a blockchain ledger based on the entity data blocks of the entity data blockchain of FIG. 1;

FIG. 6B is a data architecture diagram showing an illustrative example of smart contract code, transactions and messages that are bundled into a block so that their integrity is cryptographically secure and so that they may be appended to a blockchain ledger;

FIG. 7 is a computer architecture diagram illustrating an illustrative computer hardware and software architecture for a computing system capable of implementing aspects of the techniques and technologies presented herein;

FIG. 8 is a diagram illustrating a distributed computing environment capable of implementing aspects of the techniques and technologies presented herein; and

FIG. 9 is a computer architecture diagram illustrating a computing device architecture for a computing device capable of implementing aspects of the techniques and technologies presented herein.

### DETAILED DESCRIPTION

In the context of data management, it is sometimes advantageous to maintain and provide access to reliable data regarding an entity. For example, it is useful to have reliable and accessible information for an individual's resume that confirms the individual's education history, work history, skills inventory, or service record. Similarly, it can be useful to have reliable information for an organization, company or institution, such as accreditation history, project history or payment history. Having information that can be relied upon in decision making that does not have to be reverified for each individual or entity who wished to use the information can be useful.

The disclosed technology utilizes a blockchain smart contract that secures therein data pertaining to an entity and verifies the entity data. For example, data events such as graduation from a university, certification for compliance, or completion of a project or service can be stored on a blockchain and verified such that the data pertaining to the entity cannot be changed and is, therefore, reliable for decision making. In verification of the entity data, verification nodes with greater relevance to the nature of the entity data are given greater weight. With the use of blockchain smart contracts, entity data can be more efficiently and effectively maintained and accessed.

The following Detailed Description describes technologies for securely maintaining data pertaining to an entity using an entity data blockchain. A source entity can generate an entity data block representing a data event pertaining to an entity that is verified and securely stored on an entity data blockchain. When the entity data block is verified, greater weight is given to the votes of verification nodes with greater relevance to the nature of the entity data.

For example, a university can submit an entity data block relating to the graduation of an individual person that is verified and securely stored on an entity data blockchain for the person that can be utilized to reliably confirm the graduation of that person. During verification of the entity data block, verification nodes that are educational institutions are given greater weight in the determination to verify.

In another example, a certifying body can submit an entity data block confirming that an organization is in compliance with an industry standard that is verified and stored on an entity data blockchain for the organization. During verification of the entity data block, verification nodes that are certification institutions are given greater weight in the determination to verify.

An entity data blockchain can be established by an entity to which the data pertains, such as an individual, organization, institution, or company, or by another entity. For example, a school can establish an entity data blockchain for an individual or a state secretary of state can establish an entity data blockchain for a corporation. Alternatively, data blocks for entity data events can be generated the source and linked to an existing blockchain, such as the ETHEREUM blockchain.

A source entity generates an entity data block that includes information regarding a data event pertinent to an entity and a class of service for the entity data block. The entity data block is linked to an entity data blockchain and submitted to a cluster of verification nodes, where the verification nodes have an associated class of service. The verification nodes vote on whether to verify the entity data block, where each of the votes of the verification nodes are weighted based upon a relationship between the class of service of the entity data block and the class of service of the voting verification node. In this manner, the verification nodes with greater relevance to the nature of the entity data can be given greater weight in verification. The weighted votes of the verification nodes are utilized to calculate a verification score for the entity data block. If the verification score exceeds a verification threshold, then the entity data block is verified.

In another aspect of the disclosed technology, additional verification nodes can be added to the group of verification nodes by vote of the group of verification nodes. A new verification or candidate node is submitted for addition to the group of verification nodes. The group of verification nodes votes to accept or deny the candidate node.

The vote of each individual verification node is weighted based on a relationship between a class of service of the verification node and a class of service of the new verification node being voted upon. In this manner, the verification nodes with greater relevance to the nature of the candidate node can be given greater weight in acceptance of the candidate node.

For instance, when a new verification with a class of service related to government is being verified, a higher weight can be assigned to votes from verification nodes with a class of service related to government than votes from verification nodes with a class of service related to service organizations. A verification acceptance score is calculated based on weighted verification votes received and the new verification node is accepted to the group of verification nodes if the acceptance score exceeds a threshold.

A technical advantage of the disclosed entity data management technology includes verification of entity data with greater weight accorded to verification nodes with greater relevance to the nature of the entity data. Another technical advantage of the disclosed entity data management technology is securely maintaining the entity data on a blockchain that can be widely accessed through the internet. Still another technical advantage of the disclosed entity data management technology is the distributed nature of the blockchain, which prevents an unauthorized entity from modifying or corrupting the entity data at any single point. Yet another technical advantage of the disclosed entity data management technology is that the entity data is verified and cannot be altered so that the information can be relied upon in decision making. Further still, by storing data on a public blockchain, the storage available is elastic and scalable, and able to grow as needed.

As will be described in more detail herein, it can be appreciated that implementations of the techniques and technologies described herein may include the use of solid state circuits, digital logic circuits, computer components, and/or software executing on one or more input devices. Signals described herein may include analog and/or digital signals for communicating a changed state of the data file or other information pertaining to the data file.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including multiprocessor systems, mainframe computers, microprocessor-based or programmable consumer electronics, minicomputers, hand-held devices, and the like.

By the use of the technologies described herein, an entity data blockchain is used to securely store data pertaining to an entity on the entity data blockchain, where the data has been verified by a cluster of verification nodes. In an entity data blockchain, data blocks securely store data pertaining to an entity in a manner that provides wide access to the data so that the entity data can be readily accessed by users with network access to the blockchain. The entity data has also been verified and cannot be modified so that the data can be relied upon in decision making. For increased transparency, code for controlling verification of the entity data can be included in the entity data blocks

Other technical effects other than those mentioned herein can also be realized from implementation of the technologies disclosed herein.

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for an entity data blockchain ledger will be described. As will be described in more detail below with respect to the figures, there are a number of applications and services that may embody the functionality and techniques described herein.

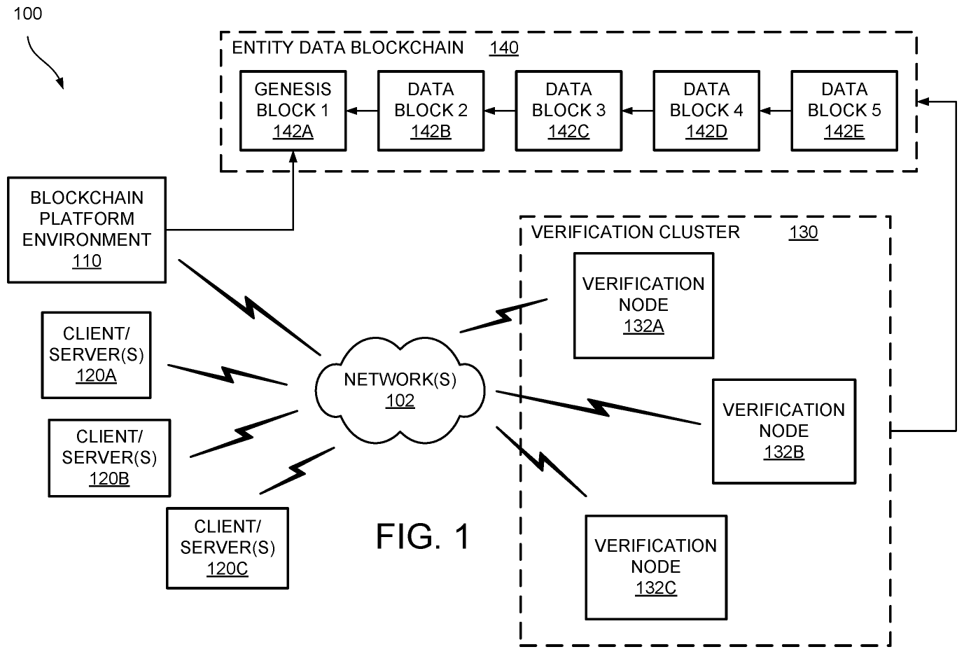

FIG. 1 is an architectural diagram showing an illustrative example of an entity data management system 100 utilizing an entity data blockchain 140. An entity data blockchain can be utilized to securely maintain verified entity data. In the embodiment of FIG. 1, blockchain 140 can be a publicly available blockchain that supports scripting, such the ETHEREUM blockchain, which supports a SOLIDITY scripting language, or BITCOIN, which supports a scripting language called SCRIPT.

In this example, a blockchain platform environment 110 supports entity data blockchain 140, which stores entity data blocks 142 containing data pertaining to a subject entity, such as an individual, institution or organization. When a data event pertaining to the subject entity occurs, for example, in a source entity utilizing one of client/servers 120, an entity data block 142 is generated that contains data for the data event and a class of service for the data, e.g. education history, work history, or service history, and linked to entity data blockchain 140. Note that the class of service for the entity data block 142 generally corresponds to the nature of the source entity that generates the data block, e.g. an educational institution creates an entity data block 142 with an education history class of service.

Verification cluster 130 composed of verification nodes 132 votes on whether to verify the entity data block. Each of the verification nodes 132 has an associated class of service, e.g. educational, employment, or governmental. The vote of each of the verification nodes 132 is weighted based on a relationship between the class of service of the entity data block 142 and the class of service of the verification node 132. For example, a verification node with an educational class of service can be given greater weight in validating an entity data block with an education history class of service than a verification node with an employment class of service. If the entity data block 142 is verified by verification cluster 130, then the entity data block 142 is committed to entity data blockchain 140.

In the example of FIG. 1, the information in the entity data blocks 142 of the blockchain is verified, secured, and can be made accessible to other entities, such as client/servers 120A, 120B or 120C or blockchain platform 110. In this example, the client/servers 120 and verification nodes 132 can communicate with blockchain platform environment 110 that supports and maintains blockchain 140. For example, the ETHEREUM blockchain platform from the ETHEREUM FOUNDATION of Switzerland provides a decentralized, distributed computing platform and operating system that provides scripting functionality.

The entity data blockchain 140 can be made accessible to other entities, such as client/servers 120, so these entities can access entity data stored in the blocks in the blockchain. For example, entity data blockchain 140 may be viewable to the public through the use of applications that can access blockchain information. By providing access to the entity data blockchain 140, this approach allows users to readily access verified entity data maintained on the entity data blockchain 140.

In another example, aspects of the entity data blockchain 140 may be restricted to being viewable only to entities that are authorized to access the blockchain 140, such as verification client/server(s) 132. By restricting access to the blockchain 140, a subject entity can preserve greater control or security over the entity data. Controls can be introduced to permit the subject entity to control access to the entity data, while the entity data cannot be modified and, therefore, remains verified.

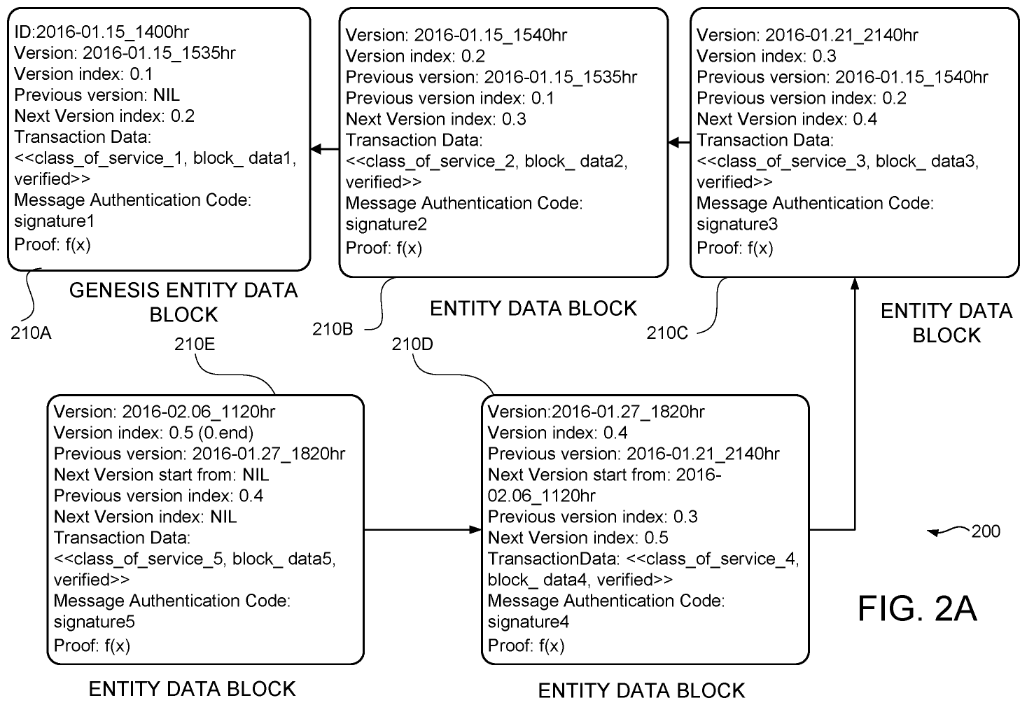

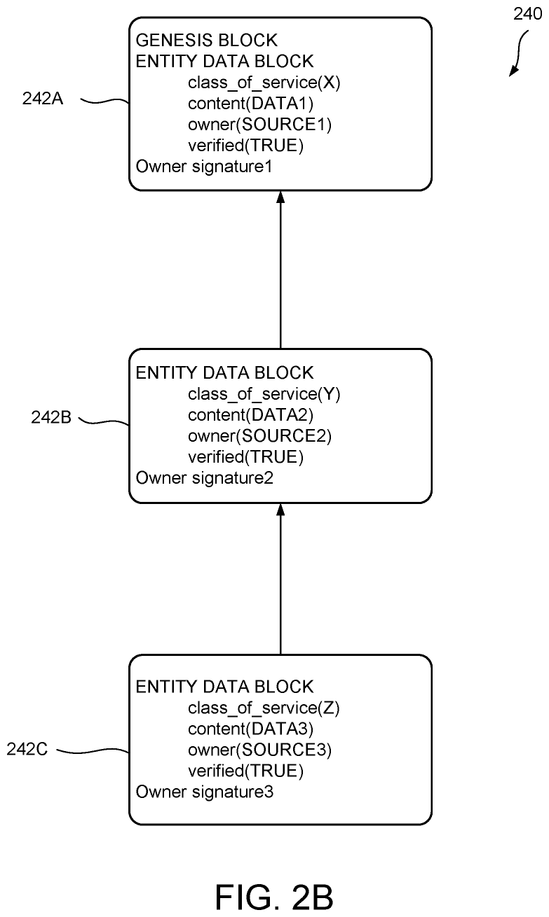

FIG. 2A is a data architecture diagram illustrating a simplified example of an entity data blockchain ledger 200 based on the entity data blocks 142A-E of the entity data blockchain ledger 140 of FIG. 1. The entity data blockchain ledger 200 example of FIG. 2A is simplified to show block headers, metadata and signatures of blocks 210A-E in order to demonstrate storage of entity data using a blockchain. In outline, a blockchain ledger may be a globally shared transactional database. Signatures can, in some examples, involve all or part of the data stored in the data the blocks 142A-E and can also involve public key addresses corresponding to entities involved in the maintenance of the entity data, e.g. a source entity, a subject entity, or a verification node.

The blockchain ledger 200 may be arranged as a Merkle tree data structure, as a linked list, or as any similar data structure that allows for cryptographic integrity. The blockchain ledger 200 allows for validation that the entity data and associated data has not been corrupted or tampered with because any attempt to tamper will change a Message Authentication Code (or has) of a block, and other blocks pointing to that block will be out of correspondence. In one embodiment of FIG. 2A, each block may point to another block. Each block may include a pointer to the other block, and a hash (or Message Authentication Code function) of the other block.

Each block in the blockchain ledger may optionally contain a proof data field. The proof data field may indicate a reward that is due. The proof may be a proof of work, a proof of stake, a proof of research, or any other data field indicating a reward is due. For example, a proof of work may indicate that computational work was performed. As another example, a proof of stake may indicate that an amount of cryptocurrency has been held for a certain amount of time. For example, if 10 units of cryptocurrency have been held for 10 days, a proof of stake may indicate 10*10=100 time units have accrued. A proof of research may indicate that research has been performed. In one example, a proof of research may indicate that a certain amount of computational work has been performed—such as exploring whether molecules interact a certain way during a computational search for an efficacious drug compound.

The blocks 210 of entity data blockchain 200 in the example of FIG. 2A shows securing entity data with a new entity data block on the blockchain. In one example, a source entity 120 of FIG. 1 provides the entity data, the class of service, and data identifying the source entity as an owner of the entity data, and an indicator of whether verification of the entity data block 210 has been completed. The source entity 120 signs the entity data block 210 and the blockchain system, e.g. blockchain platform environment 110, within which blockchain 200 is created validates the data block based on a proof function.

In the example of FIG. 2A, a block of entity data, a class of service for the entity data, and an indicator of whether the entity data has been verified is stored in the entity data blocks 210. In the example of FIG. 2A, each entity data block 210 can contain different types of entity data for the subject entity, e.g. education history, work history, etc. To add an entity data block with new entity data, a source entity creates entity data block 210B, which includes a block of entity data, e.g. block_data2, a class of service for the entity data, e.g. class_of_service_2, and a verified indicator set to FALSE. The source entity 120 signs entity data block 210B and commits block 210B to blockchain 200 for validation by the blockchain platform 110. Subsequently, verification cluster 130 will vote to verify entity data block 210B, at which point the verified indicator will be set to TRUE.

To add more entity data to the entity data blockchain 200, a source entity 120 creates entity data block 210C to secure entity data block_data3 with class_of_service_3. Similarly, entity data block 210D is created by a source entity 120 to store entity data block_data4 with class_of_service_4 and entity data block 210E is created to store entity data block_data5 with class_of_service_5.

FIG. 2B is a data architecture diagram showing another illustrative example of an entity data blockchain 240, where the entity data blocks 242 store entity data content, e.g. content(DATA1), and includes a class of service for the entity data, e.g. class of service(X), indicating the nature or type of the entity data, indicates the source of the entity data as the owner of the entity data block, e.g. owner(SOURCE1), which can take the form of a public key for the source entity. Each entity data block also stores block state in the form of a verified flag indicating whether the entity data block has been verified by a verification cluster, e.g. verified(TRUE).

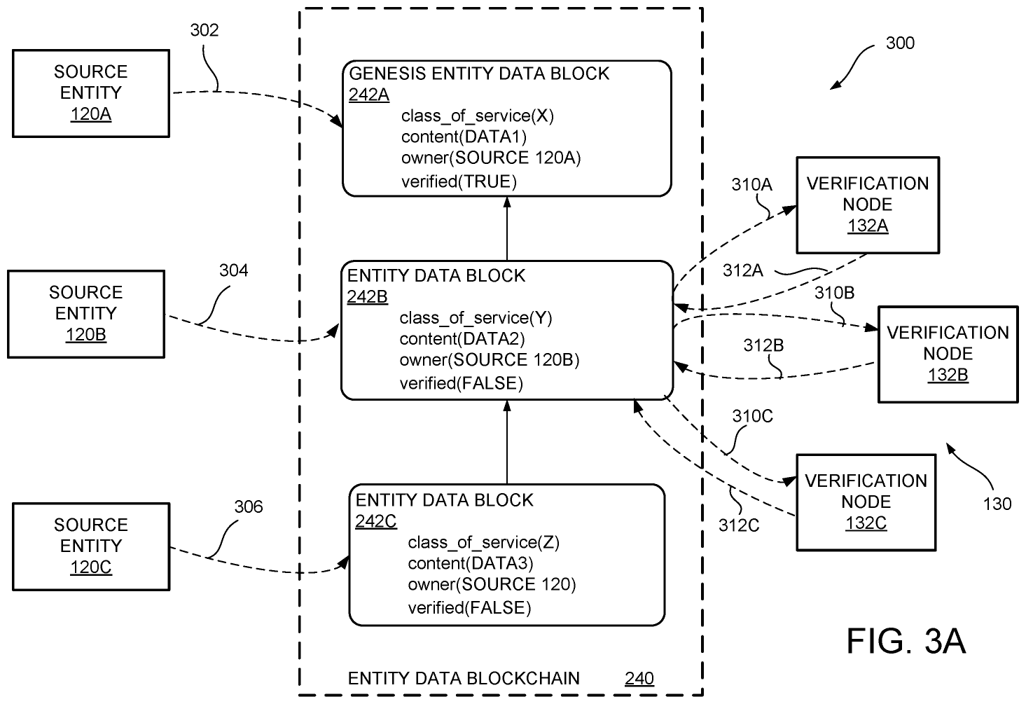

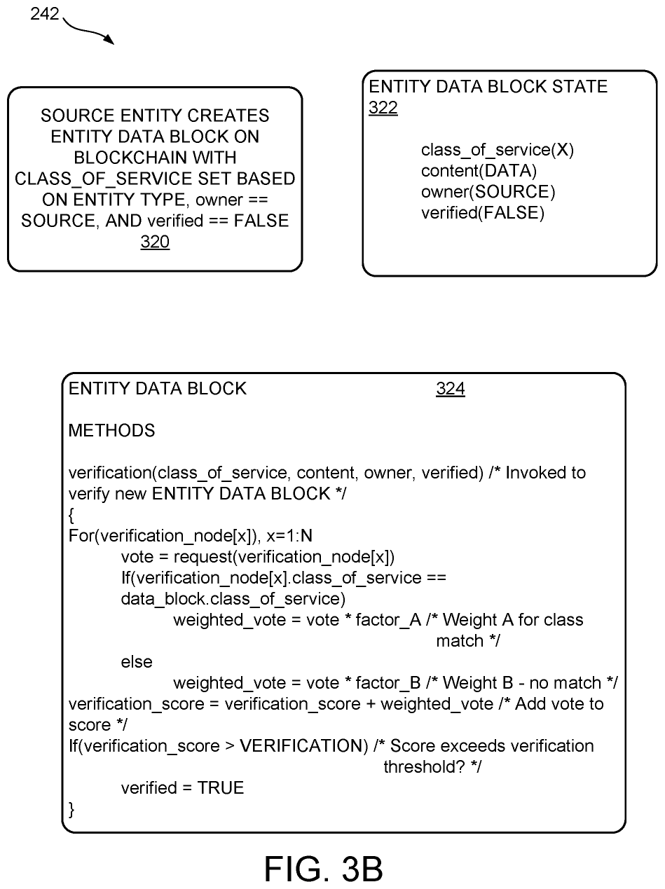

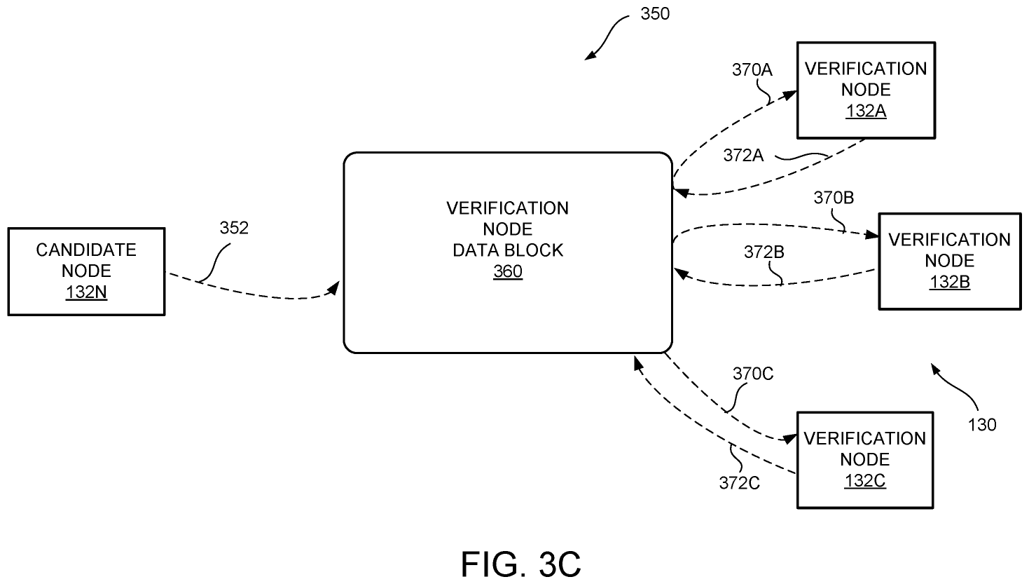

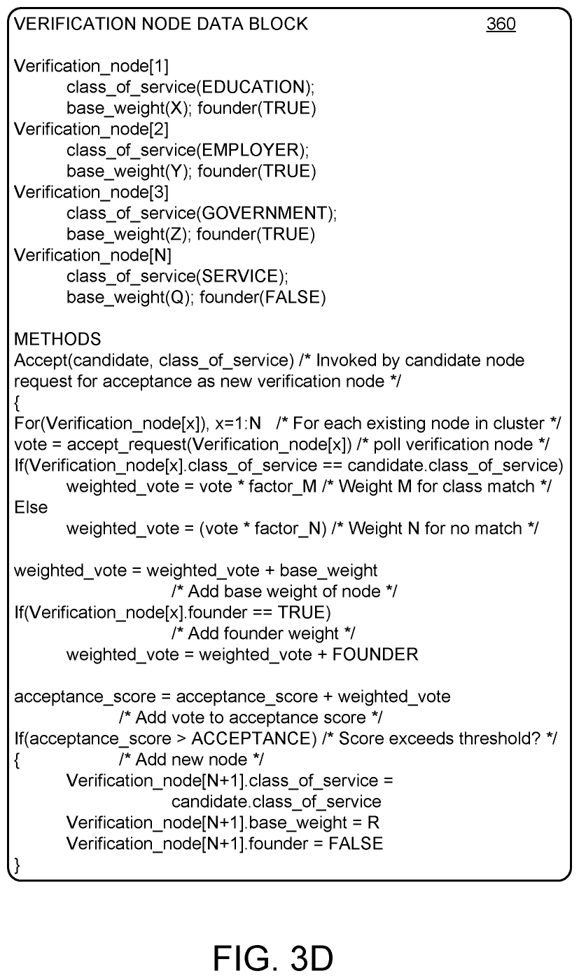

An entity data blockchain, such as blockchain 140 in FIG. 1, blockchain 200 in FIG. 2A, or blockchain 240 in FIG. 2B, enables entity data for a subject entity, e.g. an individual or an organization, to be securely stored and verified. FIG. 3A is a data architecture diagram showing a simplified illustrative example of the use of entity data blockchain 240 for source entities to securely store and entity data and verification by the verification nodes 132 of verification cluster 130.

Entity data block 242A, in this example, illustrates an initial genesis entity data block created by source entity 120A at 302. Entity data block 242A includes a class of service, e.g. class_of_service(X), for the entity data, the entity data itself, e.g. content(DATA1), and the owner or source of the entity data, e.g. owner(SOURCE 120A). These attributes of the entity data block are static.

In addition, entity data block 242A includes a verified flag that indicates whether the entity data block has been verified, which is initially set to FALSE until the entity data block is verified by a verification cluster. In the example of block 242A, verified(TRUE) indicates that the block has been verified.

At 304, source entity 120B generates entity data block 242B with class of service(Y), content(DATA2), owner(SOURCE 120B) and verified(FALSE). Entity data block 242B is then submitted to verification cluster 130 for voting by verification nodes 132A. At 310, a verification request is sent to a verification node 132, which evaluates the entity data block 242B and provides a verification vote 312.

Each verification vote 312 is weighted on the basis of a relationship between class_of_service of the entity data block 242B and a class of service of the verification node 132 to determine whether the entity data block 242B is verified, as discussed below. If verification is successful, then the verified flag for the entity data block will be set to TRUE.

Entity data block 242C, in this example, illustrates an entity data block generated, at 306, by source entity 120C. In this example, entity data block 242C has not yet been verified by verification cluster 130.

In the example of FIG. 3A, the disclosed technology enables entity data to be securely stored and verified on the entity data blockchain 240. The blockchain 240 can be made widely accessible to users of the entity data. The blockchain platform supporting the entity data blockchain ensures the integrity of the entity data and its associated ownership and verification status.

Scripts for verification of the entity data can be secured by the entity data blocks 242 of entity data blockchain 240 and executed by the operating system of the decentralized, distributed blockchain platform 110. FIG. 3B is a data architecture diagram showing an illustrative example of entity data block 242 that includes an example of a verification script. Also shown is a process 320 in a blockchain environment that creates an entity data block 242. An example of block state 322 initially defined for the entity data block 242 is also shown.

In this example, the verification script is invoked by the blockchain platform environment 110 to submit the entity data block to a verification cluster for verification. The verification script requests a vote from each verification node in the cluster. In this example, if the verification node class of service matches the entity data block class of service, then the vote is given a weight defined by factor_A. If the class_of_service does not match, then the vote is given a weight defined by factor_B, where factor_A is greater than factor_B. The weighted vote is added to a verification score that accumulates the weighted votes of the verification nodes in the verification cluster. If the verification score exceeds a defined verification threshold VERIFICATION, then the verified flag for the entity data block is set to TRUE.

Note that the weighting relationship between the class of service of the entity data block and the class of service of the verification nodes can take different forms within the disclosed technology. For example, a table defining more complex correlations between different classes of service of the entity data block and the verification nodes with different weight values can be created. For example, when the class of service of the entity data block is EDUCATIONAL HISTORY, a verification node with a class of service of EDUCATION can receive a high weight factor, a verification node with a class of service of GOVERNMENT can receive a middle weight factor, and a verification node with a class of service of EMPLOYER can receive a low weight factor.

Another aspect of the disclosed technology is the addition of nodes to a verification cluster. FIG. 3C is a data architecture diagram showing a simplified illustrative example 350 of the addition of a candidate node to a verification cluster in accordance with the disclosed technology. In this example, a verification node data block 360, which is maintained on a blockchain platform, contains data defining the verification nodes in a verification cluster. In another example, the verification node data is maintained and managed by one or more nodes of the verification cluster. One of ordinary skill in the art will readily appreciate that many other techniques for maintaining and managing the verification node data can be implemented in accordance with the disclosed technology.

Candidate node 132N submits a request 352 to be added to the verification node, which includes a class of service of the candidate node. Request 352 invokes an acceptance script in verification node data block 360 for polling the current verification nodes 132 of the verification cluster 130. The acceptance script polls, at 370, each member node 132 of the cluster 130 to obtain a vote 372 from each node 132. The votes 372 of the member nodes 132 are used to determine whether candidate node 132N will be accepted as a new member of verification cluster 130.

FIG. 3D is a data architecture diagram showing an illustrative example of verification node data block 360 that includes an example of an acceptance script. In this example, the acceptance script is secured by the verification entity data block 360 on a blockchain and executed by the operating system of the decentralized, distributed blockchain platform 110.

Verification node data block 360 includes an array of entries that identifies each verification node 132 in the verification cluster 130 along with a class of service for the node. In addition, to illustrate examples of additional data that can be utilized in particular vote weighting implementations in accordance with the disclosed technology, the entry for each verification node 132 includes a base weight and a founder flag for the node. For example, Verification_node[1] has a class of service of EDUCATION, a base weight of X, and founder set to TRUE, indicating that the node was one of the founding members of the verification node.

In this example, the Accept script is invoked by the candidate nodes request 352 for acceptance as a new verification node in verification cluster 130. Each verification node defined in the Verification node array is polled to vote on acceptance of the candidate node and each vote is weighted on the basis of the relationship between the class of service of the candidate node and the class of service of the verification node providing the vote.

In this example, if the class of service of the candidate node matches the class of service of the verification node, then the vote of the verification node is weighted by factor_M. If the class of service for the candidate and verification nodes does not match, then the vote of the verification node is weighted by factor_N, where factor_M is greater than factor_N. Similar to the discussion above regarding weights for verification of entity data, more complex relationships between classes of service for the candidate node and the verification nodes can be implemented, such as by defining the relationships and weights using a table.

In addition, the Accept script example of FIG. 3D illustrates an alternative implementation that weights the vote of each verification node based on a base weight defined for the verification node. For example, a verification node associated with the Federal Bureau of Investigation (FBI) can have a high base weight defined for it that is higher than a base weight accorded to an employer entity and gives the FBI verification node a higher weight in all votes in addition to the weighting based on class of service.

In another additional variant, the Accept script example of FIG. 3D illustrates an implementation that provides an additional weighting factor for the verification nodes that are the original members of the verification cluster, e.g. founder(TRUE). This approach affords the founding members of a verification cluster greater weight in decisions regarding membership in the cluster. Another possible approach can weight votes of verification nodes based on the length of time that the nodes has been a member of the cluster.

The weighted votes from the current verification nodes in the verification cluster are accumulated in an acceptance score. If the acceptance score exceeds a defined ACCEPTANCE threshold, then the candidate node is added to the Verification node array along with its class of service, a base weight, and the founder flag set to FALSE.

The examples discussed above involving base weight, founder flag or length of time are optional and are provided to illustrate a variety of approaches that can be implemented alongside class of service based weighting without departing from the disclosed technology. Other possible implementations will be readily apparent to one of skill in the art.

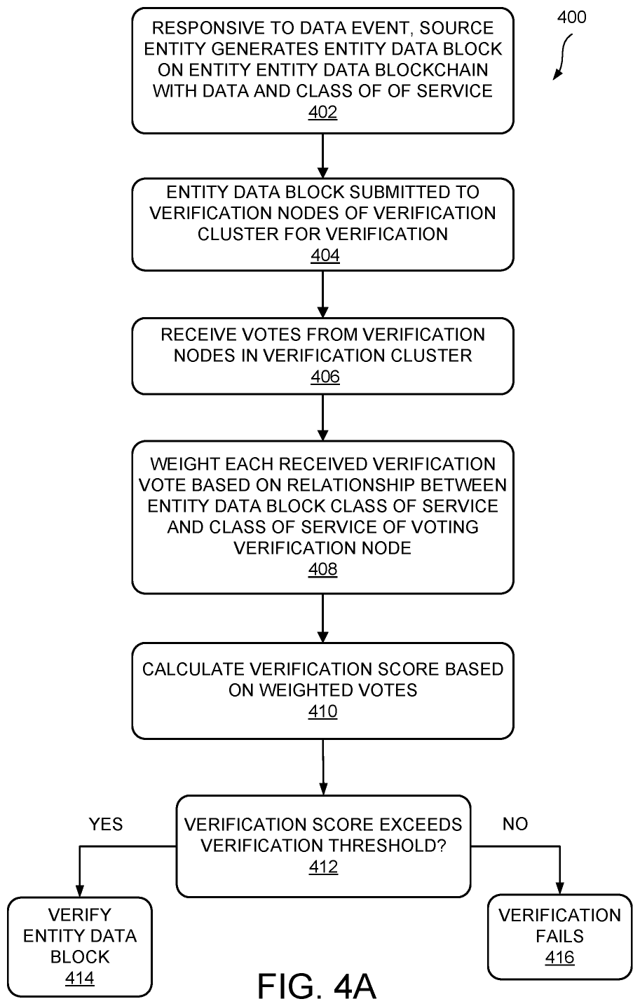

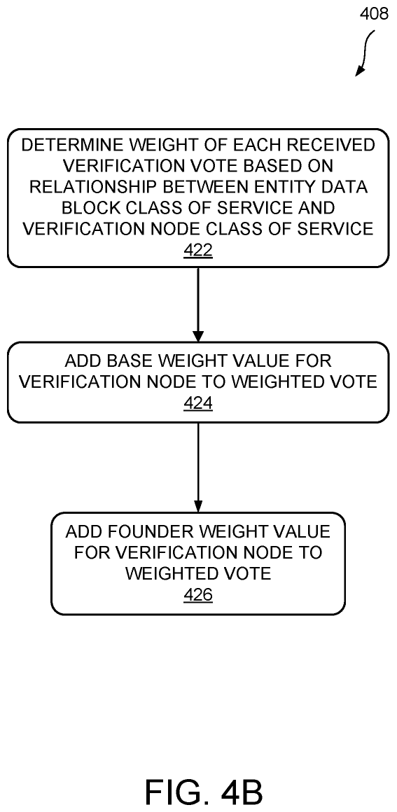

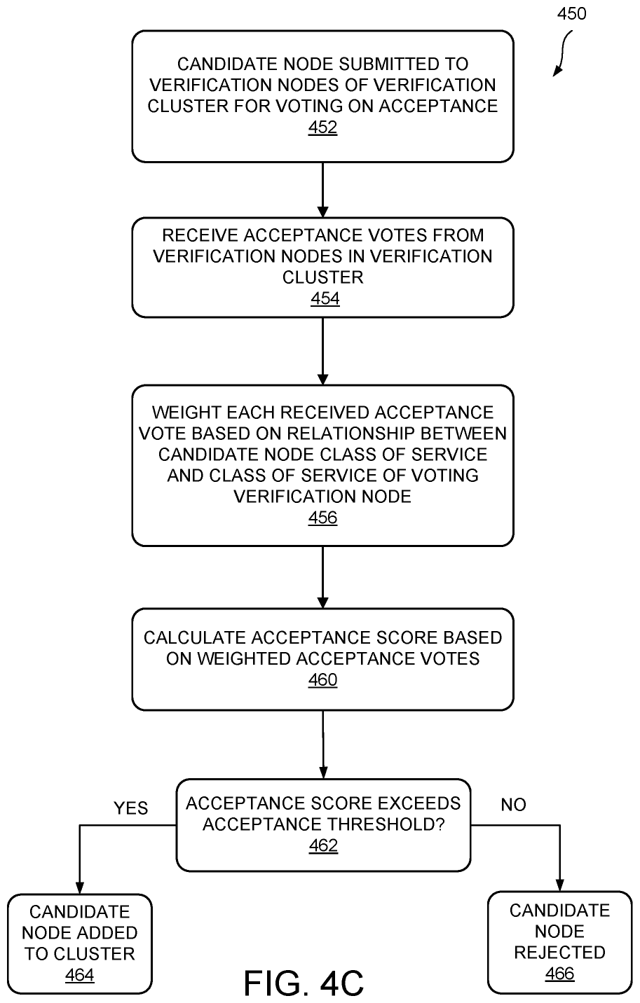

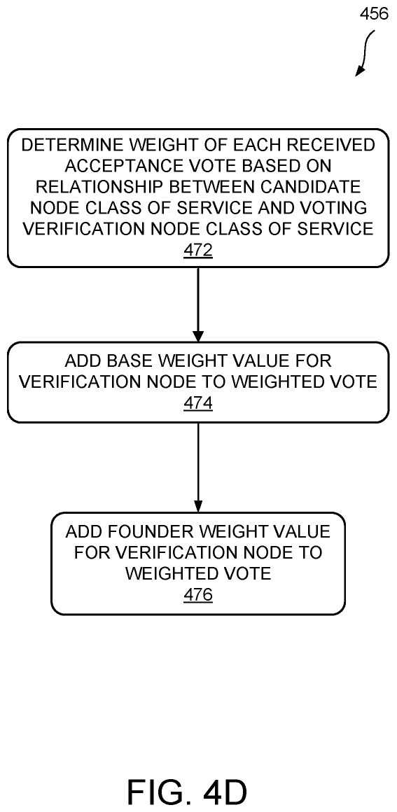

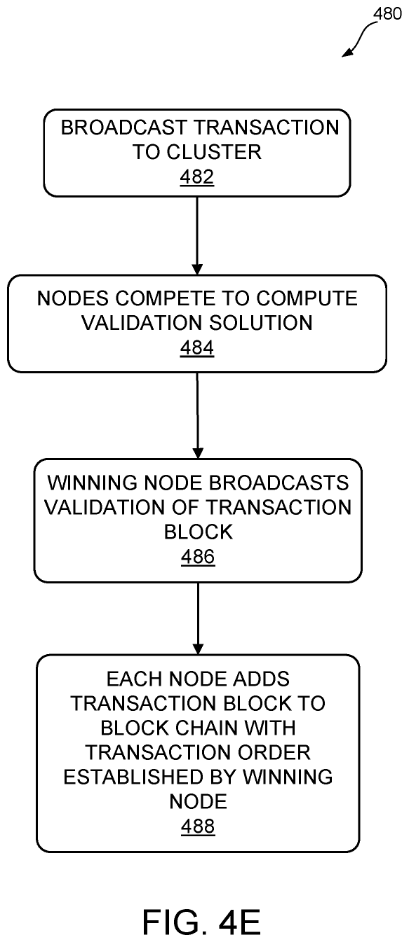

FIG. 4A is a control flow diagram showing an illustrative example of a process 400 for creating an entity data block for securely storing and verifying entity data on an entity data blockchain in accordance with the disclosed technology. This example involves, at 402, creating an entity data block on the entity data blockchain that contains the entity data and a class of service for the entity data.

The entity data block can, for example, be generated responsive to a data event in a source entity. For example, a university source entity can generate an entity data block with a class of service of EDUCATIONAL HISTORY to document a graduation. In another example, an employer source entity can generate an entity data block with a class of service of EMPLOYMENT when a project is completed. Or, in still another example, a department of motor vehicles of a state can generate an entity data block with a class of service of GOVERNMENT to document the issuance of a commercial driving license.

The entity data block created at 402 is linked to the entity data blockchain and the block is ciphered and signed by the source entity to commit the block to the entity data blockchain, such as entity data blockchain 140 in FIG. 1 or entity data blockchain 240 of FIG. 2B.

At 404, the entity data block is submitted to the verification nodes of the verification cluster for verification, e.g. verification nodes 132 of verification cluster 130. At 406, votes are received from the verification nodes in the verification cluster. At 408, each of the received verification votes is weighted based, at least in part, on a relationship between the entity data block's class of service and the class of service of the verification node that provided the vote. As described above, there are a variety of approaches to weighting the votes of verification nodes in particular implementations of the disclosed technology.

At 410, a verification score is calculated based on the weighted votes of the verification nodes. If the verification score exceeds a defined verification threshold, then control branches at 412 to 414, where the entity data block is verified, e.g. the verified flag in the entity data block is set to TRUE. In some embodiments, the verified flag can be amended by an authorized entity using an amend or emend process for blockchains. If the verification threshold is not met, then verification of the entity data block fails.

FIG. 4B is a control flow diagram showing an illustrative example of an implementation of the weighting step or operation 408 of process 400 in FIG. 4A. This example generally reflects the approach taken in the Verification script described above with respect to FIG. 3B. At 422, the weight of each received verification vote is determined based on a relationship between the entity data block class of service and the class of service of the verification node that provided the verification vote.

In this optional example, at 424, a base weight value defined for the verification node is added to the weight of the received verification vote. This approach allows specific verification nodes, e.g. FBI or law enforcement, to have an enhanced weight in the verification decision. At 426, a founder weight value defined for the verification node is added to the weight of the received verification vote. This approach allows founding members of the verification cluster to have an enhanced weight in the verification decision. As noted above, these are optional implementations and other variants are possible that are in accordance with the disclosed technology.

FIG. 4C is a control flow diagram illustrating an example of an acceptance process 450 for accepting a candidate node as a new verification node in a verification cluster. This example generally reflects the approach described above with respect to FIGS. 3C and 3D. At 452, the candidate node is submitted to the verification cluster for voting on acceptance, e.g. verification nodes 132 of verification cluster 130 are polled to vote on the candidate node. At 454, the acceptance votes are received from the verification nodes of the verification cluster.

At 456, the weight of each acceptance vote received from a verification node is determined based on a relationship between the class of service of the candidate node and the class of service of the verification node providing the note. At 460, an acceptance score for the candidate node is calculated based on the weighted acceptance votes of the verification nodes.

If the acceptance score exceeds a defined acceptance threshold, then control branches at 462 to 464 and the candidate node is added to the verification cluster, e.g. added to the verification node array in verification node data block 360 of FIG. 3D. If the acceptance threshold is not met, then the candidate node is rejected at 466.

FIG. 4D is a control flow diagram illustrating one example of an implementation of weighting step or operation 456 of FIG. 4C. This example generally reflects the approach taken in the Accept script described above with respect to FIG. 3D. At 472, the weight of each received acceptance vote is determined based on a relationship between the candidate node class of service and the class of service of the verification node that provided the acceptance vote.

In this optional example, at 474, a base weight value defined for the verification node is added to the weight of the received acceptance vote. This approach allows specific verification nodes, e.g. FBI or law enforcement, to have an enhanced weight in the acceptance decision. At 476, a founder weight value defined for the verification node is added to the weight of the received acceptance vote. This approach allows founding members of the verification cluster to have an enhanced weight in the acceptance decision. As noted above, these are optional implementations and other variants are possible that are in accordance with the disclosed technology.

FIG. 4E is a control flow diagram illustrating an example of a validation process 480 for blocks added to the entity data blockchain ledger implemented using untrusted blockchain nodes. In process 480, when an entity data block 142 is created for entity data blockchain 140, the transaction is broadcast, at 482, to the cluster of untrusted nodes. At 484, nodes compete to compute a validation solution for the transaction. At 486, a winning node broadcasts the validation solution for the entity data block and adds the entity data block to its copy of the entity data blockchain ledger. At 488, in response to the winning node's broadcast, the other nodes add the entity data block to their copies of the entity data blockchain ledger in the transaction order established by the winning node. The decentralized validation protocol can maintain the integrity and security of the entity data blockchain ledger.

It should be appreciated that the processes shown for examples and a variety of other approaches may be utilized without departing from the disclosed technology.

Depending upon the scripting capabilities of the blockchain platform, the entity data blocks of the entity data blockchain may include more extensive code execution. For example, an entity data management system that provides for controlled access to the entity data by multiple users may require more extensive code execution capability in the blockchain than an entity data management system that limits access to a single user. Similarly, an entity data management system based on an entity data blockchain that encrypts the entity data may require more extensive code execution capability in the blockchain.

It should be appreciated that the utilization of blockchain technology, such as scripting technology within smart contracts, in this context provides a high degree of flexibility and variation in the configuration of implementations without departing from the teachings of the present disclosure.

Note that the disclosed technology may be applied to controlling distribution of a variety of types of entity data, such as resume data for an individual or performance history of an organization. The technology may be applied to secure storage and distribution of the entity data. The disclosed technology can also provide for managing verification node membership in a verification node for verifying entity data.

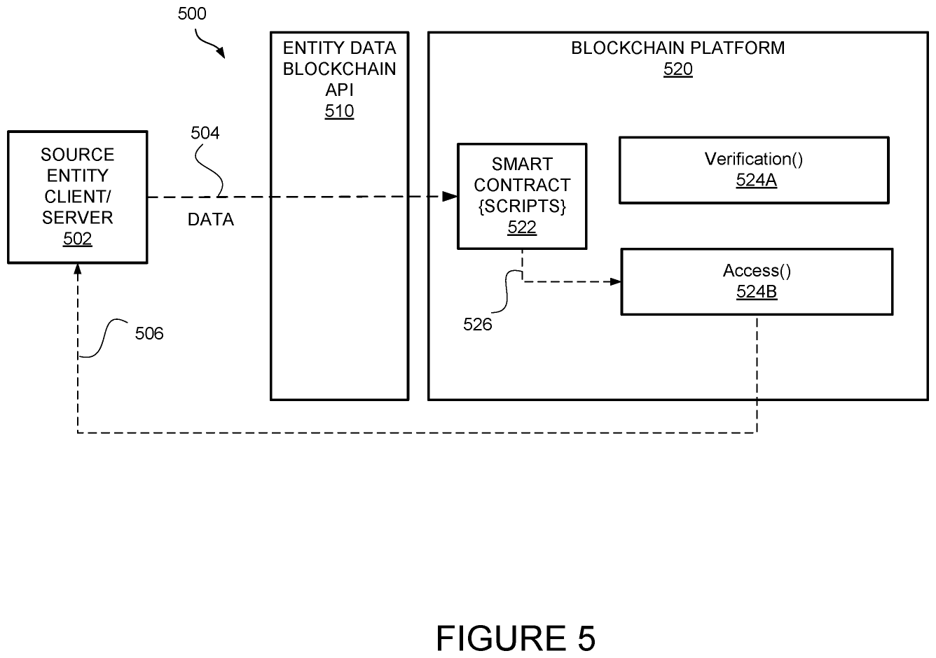

FIG. 5 is a data architecture diagram showing an illustrative example of an interface for accessing an entity data blockchain, such as blockchain 140 in FIG. 1, blockchain 200 in FIG. 2A, blockchain 240 in FIG. 2B, or blockchain 240 in FIG. 3A. In this example, an evaluation Application Program Interface (API) 510 provides an interface to the blockchain platform 520 that supports the entity data blockchain. The blockchain platform 520 supports a smart contract 522, such as entity data block 242 in FIG. 3B, which includes scripts 524 with code that, when executed by the blockchain platform 520, performs operations with respect to the entity data blockchain.

In the example of FIG. 5, three scripts are defined in smart contract 522. The Distribution script 524A permits an owner of entity data to provide access rights to a user to access entity data stored on an entity data blockchain. The Access script 524B provides for a user to request access to entity data stored on the blockchain. The Verify script is used to verify that the calling user's current use meets the required used conditions for entity data as defined on the blockchain.

In the example of FIG. 5, a user of client/server 502, sends an access requires 504 through the entity data blockchain API 510 to smart contract 522 to invoke, at 526, the Access script 524B. The Access script performs the checks described above and, if the checks are successful, distributes, at 506, the entity data to client/server 502.

### Blockchain Ledger Data Structure

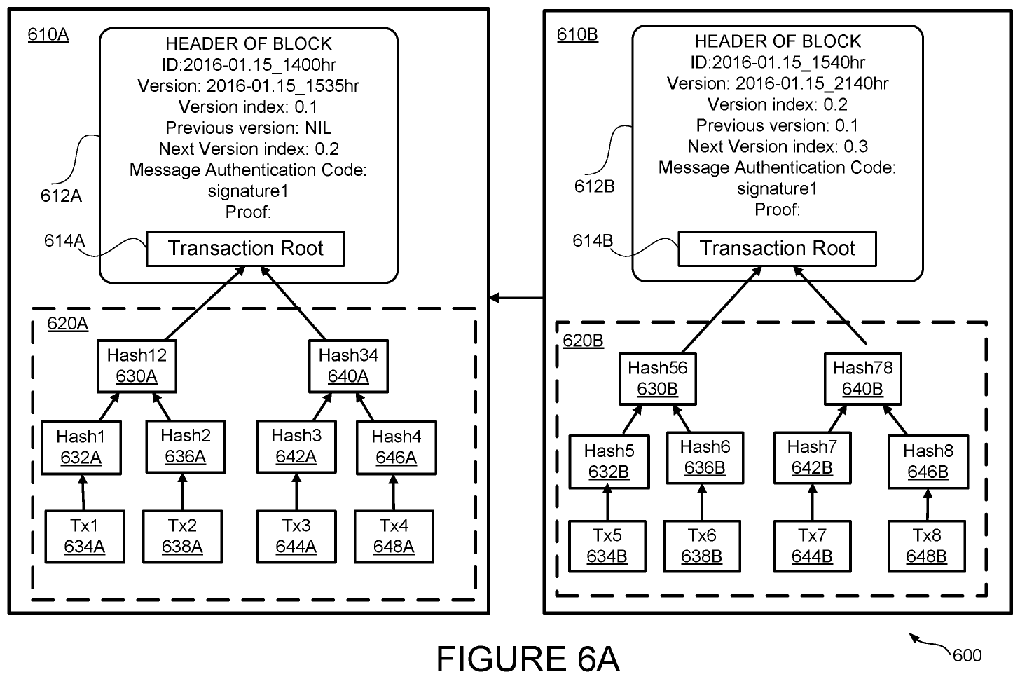

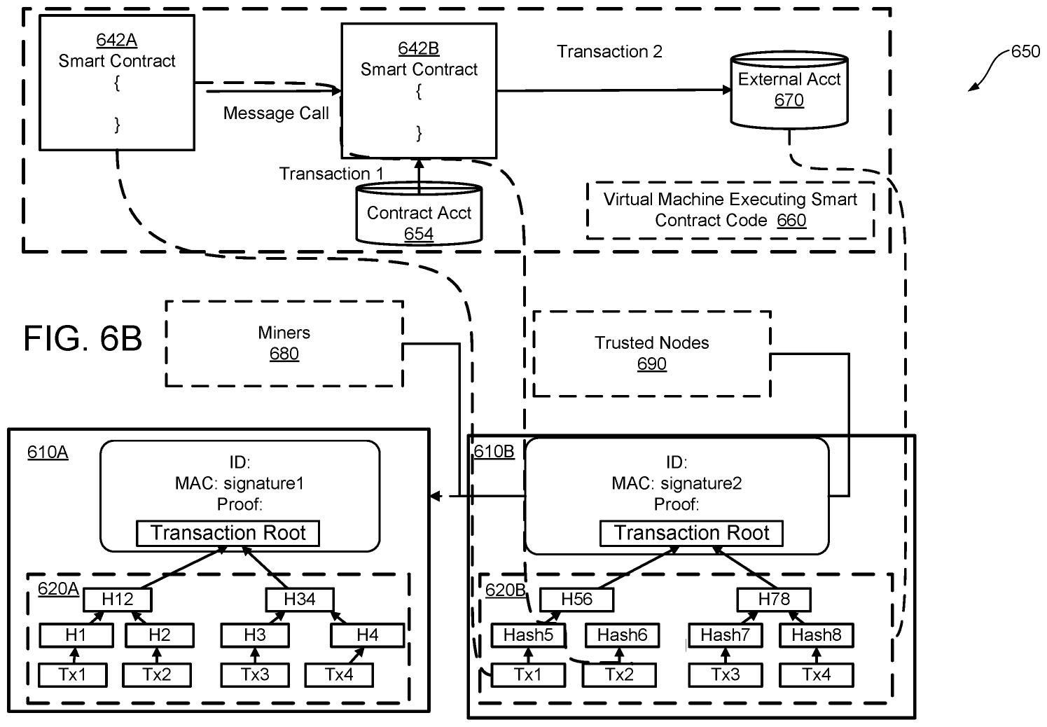

FIG. 6A is a data architecture diagram illustrating a simplified example of a blockchain ledger 600 based on the blocks 142A-E of the entity data blockchain 140 of FIG. 1. The blockchain ledger 600 example of FIG. 6A is simplified to show block headers, metadata and signatures of blocks 210A-E in order to demonstrate a secure entity data ledger using a blockchain. In outline, a blockchain ledger may be a globally shared transactional database.

FIG. 6A is an illustrative example of a blockchain ledger 600 with a data tree holding transaction data that is verified using cryptographic techniques. In FIG. 6A, each block 610 includes a block header 612 with information regarding previous and subsequent blocks and stores a transaction root node 614 to a data tree 620 holding transactional data. Transaction data may store smart contracts, data related to transactions, or any other data. The elements of smart contracts may also be stored within transaction nodes of the blocks.

In the example of FIG. 6A, a Merkle tree 620 is used to cryptographically secure the transaction data. For example, Transaction T×1 node 634A of data tree 620A of block 610A can be hashed to Hash1 node 632A, Transaction T×2 node 638A may be hashed to Hash2 node 636A. Hash1 node 632A and Hash2 node 636A may be hashed to Hash12 node 630A. A similar subtree may be formed to generate Hash34 node 640A. Hash12 node 630A and Hash34 node 640A may be hashed to Transaction Root 614A hash sorted in the entity data block 610A. By using a Merkle tree, or any similar data structure, the integrity of the transactions may be checked by verifying the hash is correct.

FIG. 6B is a data architecture diagram showing an illustrative example of smart contract code, transactions and messages that are bundled into a block so that their integrity is cryptographically secure and so that they may be appended to a blockchain ledger. In FIG. 6B, smart contracts 642 are code that executes on a computer. More specifically, the code of a smart contract may be stored in a blockchain ledger and executed by nodes of a distributed blockchain platform at a given time. The result of the smart code execution may be stored in a blockchain ledger. Optionally, a currency may be expended as smart contract code is executed. In the example of FIG. 6B, smart contracts 642 are executed in a virtual machine environment, although this is optional.

In FIG. 6B, the aspects of smart contracts 642 are stored in transaction data nodes in data tree 620 in the blocks 610 of the blockchain ledger of FIG. 6A. In the example of FIG. 6B, Smart Contract 642A is stored in data block T×1 node 634A of data tree 620A in block 610A, Smart Contract 642B is stored in T×2 node 638A, Contract Account 654 associated with Smart Contract 642B is stored in T×3 node 644A, and External Account is stored in T×4 node 648A.

### Storage of Smart Contracts and Transaction Data in the Blockchain Ledger

To ensure the smart contracts are secure and generate secure data, the blockchain ledger must be kept up to date. For example, if a smart contract is created, the code associated with a smart contract must be stored in a secure way. Similarly, when smart contract code executes and generates transaction data, the transaction data must be stored in a secure way.

In the example of FIG. 6B, two possible embodiments for maintenance of the blockchain ledger are shown. In one embodiment, untrusted miner nodes (“miners”) 680 may be rewarded for solving a cryptographic puzzle and thereby be allowed to append a block to the blockchain. Alternatively, a set of trusted nodes 690 may be used to append the next block to the blockchain ledger. Nodes may execute smart contract code, and then one winning node may append the next block to a blockchain ledger.

Though aspects of the technology disclosed herein resemble a smart contract, in the present techniques, the policy of the contract may determine the way that the blockchain ledger is maintained. For example, the policy may require that the verification or authorization process for blocks on the ledger is determined by a centralized control of a cluster of trusted nodes. In this case, the centralized control may be a trusted node, such as source environment 110, authorized to attest and sign the transaction blocks to verify them and verification by miners may not be needed.

Alternatively, the policy may provide for verification process decided by a decentralized cluster of untrusted nodes. In the situation where the blockchain ledger is distributed to a cluster of untrusted nodes, mining of blocks in the chain may be employed to verify the blockchain ledger.

Blockchains may use various time-stamping schemes, such as proof-of-work, to serialize changes. Alternate consensus methods include proof-of-stake, proof-of-burn, proof-of-research may also be utilized to serialize changes.

As noted above, in some examples, a blockchain ledger may be verified by miners to secure the blockchain. In this case, miners may collectively agree on a verification solution to be utilized. However, if a small network is utilized, e.g. private network, then the solution may be a Merkle tree and mining for the verification solution may not be required. When a transaction block is created, e.g. an entity data block 142 for entity data blockchain 140, the block is an unconfirmed and unidentified entity. To be part of the acknowledged “currency”, it may be added to the blockchain, and therefore relates to the concept of a trusted cluster.

In a trusted cluster, when an entity data block 142 is added, every node competes to acknowledge the next “transaction” (e.g. a new entity data block). In one example, the nodes compete to mine and get the lowest hash value: min{previous_hash, contents_hash, random_nonce_to_be_guessed}->result. Transaction order is protected by the computational race (faith that no one entity can beat the collective resources of the blockchain network). Mutual authentication parameters are broadcast and acknowledged to prevent double entries in the blockchain.

Alternatively, by broadcasting the meta-data for authenticating a secure ledger across a restricted network, e.g. only the signed hash is broadcast, the blockchain may reduce the risks that come with data being held centrally. Decentralized consensus makes blockchains suitable for the recording of secure transactions or events. The meta-data, which may contain information related to the data file, may also be ciphered for restricted access so that the meta-data does not disclose information pertaining to the data file.

The mining process, such as may be used in concert with the verification process 480 of FIG. 4F, may be utilized to deter double accounting, overriding or replaying attacks, with the community arrangement on the agreement based on the “good faith” that no single node can control the entire cluster. A working assumption for mining is the existence of equivalent power distribution of honest parties with supremacy over dishonest or compromised ones. Every node or miner in a decentralized system has a copy of the blockchain. No centralized “official” copy exists and no user is “trusted” more than any other. Transactions are broadcast, at 482, to the network using software. Mining nodes compete, at 484, to compute a verification solution to verify transactions, and then broadcast, at 486, the completed block verification to other nodes. Each node adds the block, at 488, to its copy of the blockchain with transaction order established by the winning node.

Note that in a restricted network, stake-holders who are authorized to check or mine for the data file may or may not access the transaction blocks themselves, but would need to have keys to the meta-data (since they are members of the restricted network, and are trusted) to get the details. As keys are applied on data with different data classifications, the stake-holders can be segmented.

A decentralized blockchain may also use ad-hoc secure message passing and distributed networking. In this example, the entity data blockchain ledger may be different from a conventional blockchain in that there is a centralized clearing house, e.g. authorized central control for verification. Without the mining process, the trusted cluster can be contained in a centralized blockchain instead of a public or democratic blockchain. One way to view this is that a decentralized portion is as “democratic N honest parties” (multiparty honest party is a cryptography concept), and a centralized portion as a “trusted monarchy for blockchain information correction”. For example, there may be advantages to maintaining the data file as centrally authorized and kept offline.

In some examples, access to a distributed entity data blockchain may be restricted by cryptographic means to be only open to authorized servers. Since the entity data blockchain ledger is distributed, the authorized servers can verify it. A public key may be used as an address on a public blockchain ledger.

Note that growth of a decentralized blockchain may be accompanied by the risk of node centralization because the computer resources required to operate on bigger data become increasingly expensive.

The present techniques may involve operations occurring in one or more machines. As used herein, “machine” means physical data-storage and processing hardware programed with instructions to perform specialized computing operations. It is to be understood that two or more different machines may share hardware components. For example, the same integrated circuit may be part of two or more different machines.

One of ordinary skill in the art will recognize that a wide variety of approaches may be utilized and combined with the present approach involving an entity data blockchain ledger. The specific examples of different aspects of an entity data blockchain ledger described herein are illustrative and are not intended to limit the scope of the techniques shown.

### Smart Contracts

Smart contracts are defined by code. As described previously, the terms and conditions of the smart contract may be encoded (e.g., by hash) into a blockchain ledger. Specifically, smart contracts may be compiled into a bytecode (if executed in a virtual machine), and then the bytecode may be stored in a blockchain ledger as described previously. Similarly, transaction data executed and generated by smart contracts may be stored in the blockchain ledger in the ways previously described.

### Computer Architectures for Use of Smart Contracts and Blockchain Ledgers

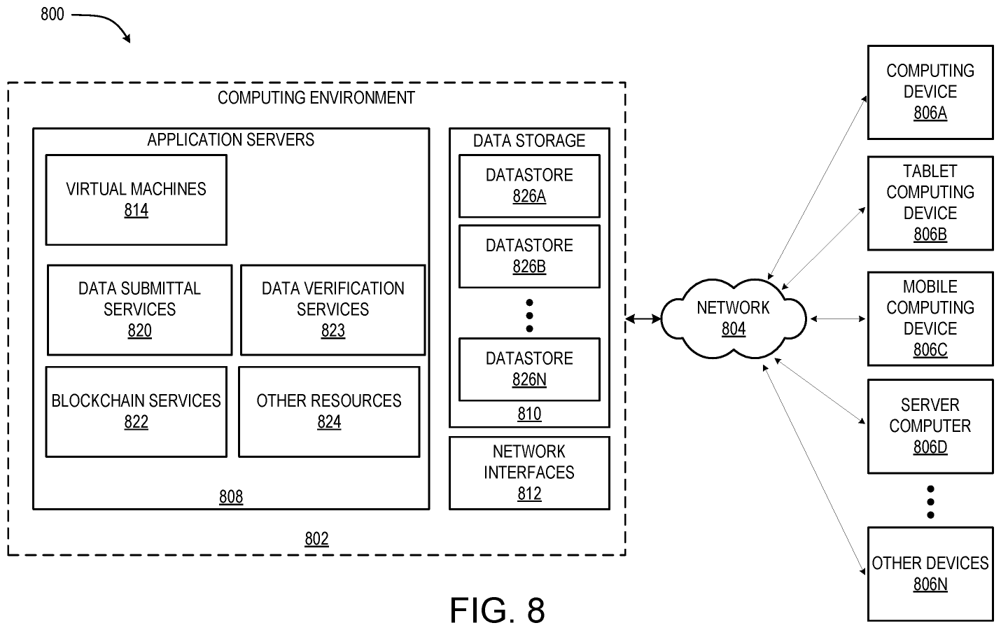

Note that at least parts of processes 400, 410, 420, 440, 460 and 480 of FIGS. 4A, 4B, 4C, 4D, 4E, and 4F, the scripts of entity data block 242 of FIG. 3B, smart contract 522 of FIG. 5, smart contracts 642 of FIG. 6B, and other processes and operations pertaining to an entity data blockchain ledger described herein may be implemented in one or more servers, such as computer environment 800 in FIG. 8, or the cloud, and data defining the results of user control input signals translated or interpreted as discussed herein may be communicated to a user device for display. Alternatively, the entity data blockchain ledger processes may be implemented in a client device. In still other examples, some operations may be implemented in one set of computing resources, such as servers, and other steps may be implemented in other computing resources, such as a client device.

It should be understood that the methods described herein can be ended at any time and need not be performed in their entireties. Some or all operations of the methods described herein, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

As described herein, in conjunction with the FIGURES described herein, the operations of the routines (e.g. processes 400, 410, 420, 440, 460 and 480 of FIGS. 4A, 4B, 4C, 4D, 4E, and 4F, the scripts of entity data block 242 of FIG. 3B, smart contract 522 of FIG. 5, smart contracts 642 of FIG. 6B) are described herein as being implemented, at least in part, by an application, component, and/or circuit. Although the following illustration refers to the components of FIGS. 1, 3B, 4A, 4B, 4C, 4D, 4E, 4F, 5 and 6B, it can be appreciated that the operations of the routines may be also implemented in many other ways. For example, the routines may be implemented, at least in part, by a computer processor or a processor or processors of another computer. In addition, one or more of the operations of the routines may alternatively or additionally be implemented, at least in part, by a computer working alone or in conjunction with other software modules.

For example, the operations of routines are described herein as being implemented, at least in part, by an application, component and/or circuit, which are generically referred to herein as modules. In some configurations, the modules can be a dynamically linked library (DLL), a statically linked library, functionality produced by an application programing interface (API), a compiled program, an interpreted program, a script or any other executable set of instructions. Data and/or modules, such as the data and modules disclosed herein, can be stored in a data structure in one or more memory components. Data can be retrieved from the data structure by addressing links or references to the data structure.

Although the following illustration refers to the components of the FIGURES discussed above, it can be appreciated that the operations of the routines (e.g. processes 400, 410, 420, 440, 460 and 480 of FIGS. 4A, 4B, 4C, 4D, 4E, and 4F, the scripts of entity data block 242 of FIG. 3B, smart contract 522 of FIG. 5, smart contracts 642 of FIG. 6B) may be also implemented in many other ways. For example, the routines may be implemented, at least in part, by a processor of another remote computer or a local computer or circuit. In addition, one or more of the operations of the routines may alternatively or additionally be implemented, at least in part, by a chipset working alone or in conjunction with other software modules. Any service, circuit or application suitable for providing the techniques disclosed herein can be used in operations described herein.

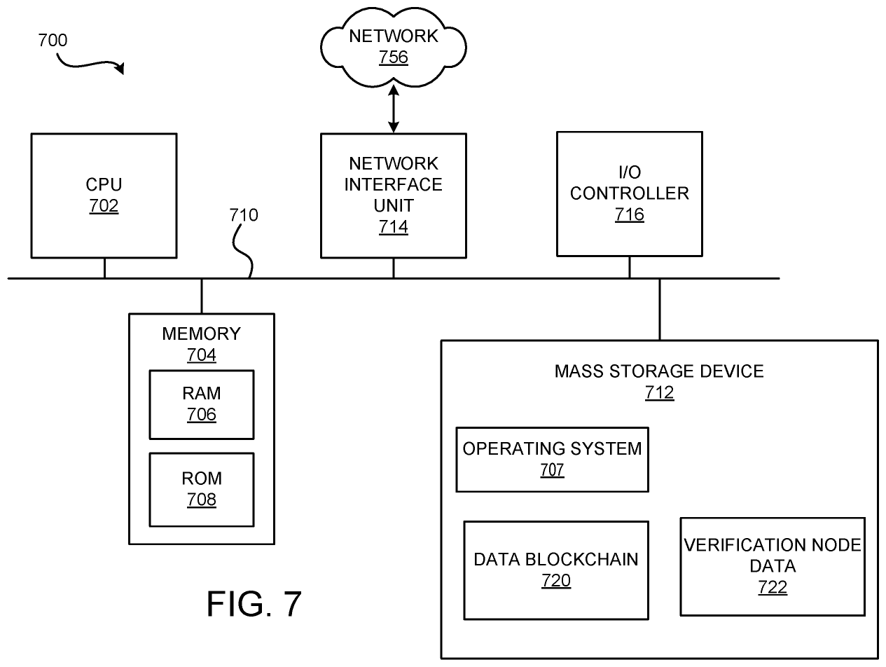

FIG. 7 shows additional details of an example computer architecture 700 for a computer, such as the devices 110 and 120A-C (FIG. 1), capable of executing the program components described herein. Thus, the computer architecture 700 illustrated in FIG. 7 illustrates an architecture for a server computer, mobile phone, a PDA, a smart phone, a desktop computer, a netbook computer, a tablet computer, an on-board computer, a game console, and/or a laptop computer. The computer architecture 700 may be utilized to execute any aspects of the software components presented herein.

The computer architecture 700 illustrated in FIG. 7 includes a central processing unit 702 (“CPU”), a system memory 704, including a random access memory 706 (“RAM”) and a read-only memory (“ROM”) 708, and a system bus 710 that couples the memory 704 to the CPU 702. A basic input/output system containing the basic routines that help to transfer information between sub-elements within the computer architecture 700, such as during startup, is stored in the ROM 708. The computer architecture 700 further includes a mass storage device 712 for storing an operating system 707, data (such as a copy of entity data blockchain data 720), and one or more application programs.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a solid-state drive, a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes the claims, the phrase “computer storage medium,” “computer-readable storage medium” and variations thereof, does not include waves, signals, and/or other transitory and/or intangible communication media, per se.

According to various configurations, the computer architecture 700 may operate in a networked environment using logical connections to remote computers through the network 756 and/or another network (not shown). The computer architecture 700 may connect to the network 756 through a network interface unit 714 connected to the bus 710. It should be appreciated that the network interface unit 714 also may be utilized to connect to other types of networks and remote computer systems. The computer architecture 700 also may include an input/output controller 716 for receiving and processing input from a number of other devices, including a keyboard, mouse, game controller, television remote or electronic stylus (not shown in FIG. 7). Similarly, the input/output controller 716 may provide output to a display screen, a printer, or other type of output device (also not shown in FIG. 7).

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7.

FIG. 8 depicts an illustrative distributed computing environment 800 capable of executing the software components described herein for an entity data blockchain ledger. Thus, the distributed computing environment 800 illustrated in FIG. 8 can be utilized to execute many aspects of the software components presented herein. For example, the distributed computing environment 800 can be utilized to execute one or more aspects of the software components described herein. Also, the distributed computing environment 800 may represent components of the distributed blockchain platform discussed above.

According to various implementations, the distributed computing environment 800 includes a computing environment 802 operating on, in communication with, or as part of the network 804. The network 804 may be or may include the network 556, described above. The network 804 also can include various access networks. One or more client devices 806A-806N (hereinafter referred to collectively and/or generically as “clients 806”) can communicate with the computing environment 802 via the network 804 and/or other connections (not illustrated in FIG. 8). In one illustrated configuration, the clients 806 include a computing device 806A, such as a laptop computer, a desktop computer, or other computing device; a slate or tablet computing device (“tablet computing device”) 806B; a mobile computing device 806C such as a mobile telephone, a smart phone, an on-board computer, or other mobile computing device; a server computer 806D; and/or other devices 806N, which can include a hardware security module. It should be understood that any number of devices 806 can communicate with the computing environment 802. Two example computing architectures for the devices 806 are illustrated and described herein with reference to FIGS. 7 and 8. It should be understood that the illustrated devices 806 and computing architectures illustrated and described herein are illustrative only and should not be construed as being limited in any way.

In the illustrated configuration, the computing environment 802 includes application servers 808, data storage 810, and one or more network interfaces 812. According to various implementations, the functionality of the application servers 808 can be provided by one or more server computers that are executing as part of, or in communication with, the network 804. The application servers 808 can host various services, virtual machines, portals, and/or other resources. In the illustrated configuration, the application servers 808 host one or more virtual machines 814 for hosting applications or other functionality. According to various implementations, the virtual machines 814 host one or more applications and/or software modules for a data management blockchain ledger. It should be understood that this configuration is illustrative only and should not be construed as being limiting in any way.

According to various implementations, the application servers 808 also include one or more data submittal services 820, one or more blockchain services 822, and data verification services 823. The data file management services 820 can include services for managing a data file on an entity data blockchain, such as entity data blockchain 140 in FIG. 1. The blockchain services 822 can include services for participating in management of one or more blockchains, such as by creating genesis blocks, entity data blocks, and performing validation. The data verification services 823 can include services for the verification of submitted data, which can include participating as a verification node.

As shown in FIG. 8, the application servers 808 also can host other services, applications, portals, and/or other resources (“other resources”) 824. The other resources 824 can include, but are not limited to, data encryption, data sharing, or any other functionality.

As mentioned above, the computing environment 802 can include data storage 810. According to various implementations, the functionality of the data storage 810 is provided by one or more databases or data stores operating on, or in communication with, the network 804. The functionality of the data storage 810 also can be provided by one or more server computers configured to host data for the computing environment 802. The data storage 810 can include, host, or provide one or more real or virtual data stores 826A-826N (hereinafter referred to collectively and/or generically as “datastores 826”). The datastores 826 are configured to host data used or created by the application servers 808 and/or other data. Aspects of the datastores 826 may be associated with services for an entity data blockchain. Although not illustrated in FIG. 8, the datastores 826 also can host or store web page documents, word documents, presentation documents, data structures, algorithms for execution by a recommendation engine, and/or other data utilized by any application program or another module.

The computing environment 802 can communicate with, or be accessed by, the network interfaces 812. The network interfaces 812 can include various types of network hardware and software for supporting communications between two or more computing devices including, but not limited to, the clients 806 and the application servers 808. It should be appreciated that the network interfaces 812 also may be utilized to connect to other types of networks and/or computer systems.

It should be understood that the distributed computing environment 800 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 800 may provide the software functionality described herein as a service to the clients using devices 806. It should be understood that the devices 806 can include real or virtual machines including, but not limited to, server computers, web servers, personal computers, mobile computing devices, smart phones, and/or other devices, which can include user input devices. As such, various configurations of the concepts and technologies disclosed herein enable any device configured to access the distributed computing environment 800 to utilize the functionality described herein for creating and supporting an entity data blockchain ledger, among other aspects.

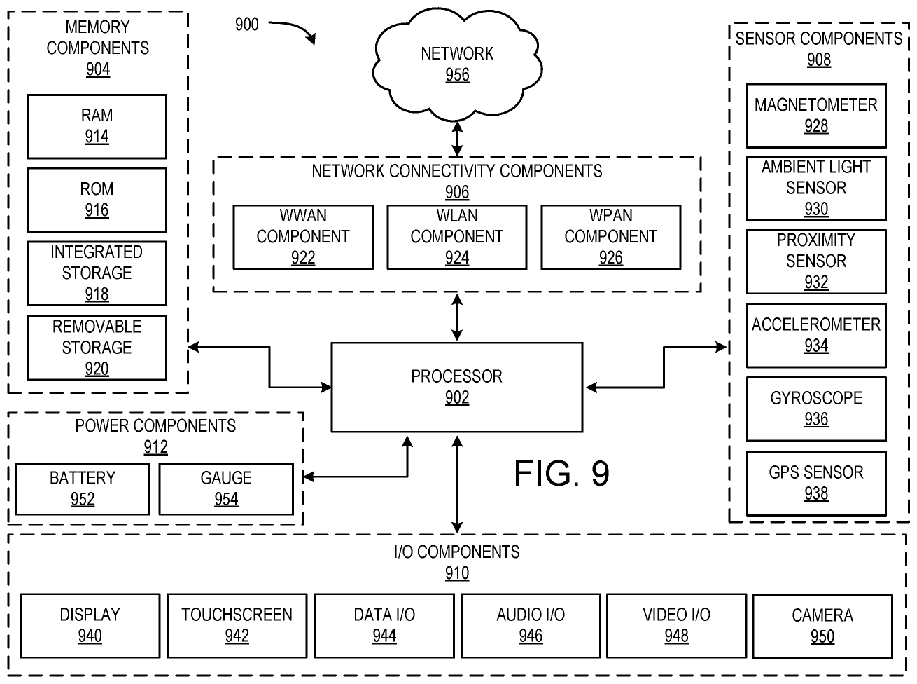

Turning now to FIG. 9, an illustrative computing device architecture 900 for a computing device that is capable of executing various software components is described herein for an entity data blockchain ledger. The computing device architecture 900 is applicable to computing devices that can manage an entity data blockchain ledger. In some configurations, the computing devices include, but are not limited to, mobile telephones, on-board computers, tablet devices, slate devices, portable video game devices, traditional desktop computers, portable computers (e.g., laptops, notebooks, ultra-portables, and netbooks), server computers, game consoles, and other computer systems. The computing device architecture 900 is applicable to the source environment 110, verification client/server(s) 112, and client/servers 120A-C shown in FIG. 1 and computing device 806A-N shown in FIG. 8.

The computing device architecture 900 illustrated in FIG. 9 includes a processor 902, memory components 904, network connectivity components 906, sensor components 908, input/output components 910, and power components 912. In the illustrated configuration, the processor 902 is in communication with the memory components 904, the network connectivity components 906, the sensor components 908, the input/output (“I/O”) components 910, and the power components 912. Although no connections are shown between the individual components illustrated in FIG. 9, the components can interact to carry out device functions. In some configurations, the components are arranged so as to communicate via one or more busses (not shown).

The processor 902 includes a central processing unit (“CPU”) configured to process data, execute computer-executable instructions of one or more application programs, and communicate with other components of the computing device architecture 900 in order to perform various functionality described herein. The processor 902 may be utilized to execute aspects of the software components presented herein and, particularly, those that utilize, at least in part, secure data.

In some configurations, the processor 902 includes a graphics processing unit (“GPU”) configured to accelerate operations performed by the CPU, including, but not limited to, operations performed by executing secure computing applications, general-purpose scientific and/or engineering computing applications, as well as graphics-intensive computing applications such as high resolution video (e.g., 620P, 1080P, and higher resolution), video games, three-dimensional (“3D”) modeling applications, and the like. In some configurations, the processor 902 is configured to communicate with a discrete GPU (not shown). In any case, the CPU and GPU may be configured in accordance with a co-processing CPU/GPU computing model, wherein a sequential part of an application executes on the CPU and a computationally-intensive part is accelerated by the GPU.

In some configurations, the processor 902 is, or is included in, a system-on-chip (“SoC”) along with one or more of the other components described herein below. For example, the SoC may include the processor 902, a GPU, one or more of the network connectivity components 906, and one or more of the sensor components 908. In some configurations, the processor 902 is fabricated, in part, utilizing a package-on-package (“PoP”) integrated circuit packaging technique. The processor 902 may be a single core or multi-core processor.

The processor 902 may be created in accordance with an ARM architecture, available for license from ARM HOLDINGS of Cambridge, United Kingdom. Alternatively, the processor 902 may be created in accordance with an x86 architecture, such as is available from INTEL CORPORATION of Mountain View, Calif. and others. In some configurations, the processor 902 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 904 include a random access memory (“RAM”) 914, a read-only memory (“ROM”) 916, an integrated storage memory (“integrated storage”) 918, and a removable storage memory (“removable storage”) 920. In some configurations, the RAM 914 or a portion thereof, the ROM 916 or a portion thereof, and/or some combination of the RAM 914 and the ROM 916 is integrated in the processor 902. In some configurations, the ROM 916 is configured to store a firmware, an operating system or a portion thereof (e.g., operating system kernel), and/or a bootloader to load an operating system kernel from the integrated storage 918 and/or the removable storage 920.

The integrated storage 918 can include a solid-state memory, a hard disk, or a combination of solid-state memory and a hard disk. The integrated storage 918 may be soldered or otherwise connected to a logic board upon which the processor 902 and other components described herein also may be connected. As such, the integrated storage 918 is integrated in the computing device. The integrated storage 918 is configured to store an operating system or portions thereof, application programs, data, and other software components described herein.

The removable storage 920 can include a solid-state memory, a hard disk, or a combination of solid-state memory and a hard disk. In some configurations, the removable storage 920 is provided in lieu of the integrated storage 918. In other configurations, the removable storage 920 is provided as additional optional storage. In some configurations, the removable storage 920 is logically combined with the integrated storage 918 such that the total available storage is made available as a total combined storage capacity. In some configurations, the total combined capacity of the integrated storage 918 and the removable storage 920 is shown to a user instead of separate storage capacities for the integrated storage 918 and the removable storage 920.

The removable storage 920 is configured to be inserted into a removable storage memory slot (not shown) or other mechanism by which the removable storage 920 is inserted and secured to facilitate a connection over which the removable storage 920 can communicate with other components of the computing device, such as the processor 902. The removable storage 920 may be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 904 can store an operating system. According to various configurations, the operating system may include, but is not limited to, server operating systems such as various forms of UNIX certified by The Open Group and LINUX certified by the Free Software Foundation, or aspects of Software-as-a-Service (SaaS) architectures, such as MICROSFT AZURE from Microsoft Corporation of Redmond, Wash. or AWS from Amazon Corporation of Seattle, Wash. The operating system may also include WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, MAC OS or IOS from Apple Inc. of Cupertino, Calif., and ANDROID OS from Google Inc. of Mountain View, Calif. Other operating systems are contemplated.

The network connectivity components 906 include a wireless wide area network component (“WWAN component”) 922, a wireless local area network component (“WLAN component”) 924, and a wireless personal area network component (“WPAN component”) 926. The network connectivity components 906 facilitate communications to and from the network 956 or another network, which may be a WWAN, a WLAN, or a WPAN. Although only the network 956 is illustrated, the network connectivity components 906 may facilitate simultaneous communication with multiple networks, including the network 956 of FIG. 9. For example, the network connectivity components 906 may facilitate simultaneous communications with multiple networks via one or more of a WWAN, a WLAN, or a WPAN.

The network 956 may be or may include a WWAN, such as a mobile telecommunications network utilizing one or more mobile telecommunications technologies to provide voice and/or data services to a computing device utilizing the computing device architecture 900 via the WWAN component 922. The mobile telecommunications technologies can include, but are not limited to, Global System for Mobile communications (“GSM”), Code Division Multiple Access (“CDMA”) ONE, CDMA7000, Universal Mobile Telecommunications System (“UMTS”), Long Term Evolution (“LTE”), and Worldwide Interoperability for Microwave Access (“WiMAX”). Moreover, the network 956 may utilize various channel access methods (which may or may not be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications may be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 956 may be configured to provide voice and/or data communications with any combination of the above technologies. The network 956 may be configured to or be adapted to provide voice and/or data communications in accordance with future generation technologies.

In some configurations, the WWAN component 922 is configured to provide dual-multi-mode connectivity to the network 956. For example, the WWAN component 922 may be configured to provide connectivity to the network 956, wherein the network 956 provides service via GSM and UMTS technologies, or via some other combination of technologies. Alternatively, multiple WWAN components 922 may be utilized to perform such functionality, and/or provide additional functionality to support other non-compatible technologies (i.e., incapable of being supported by a single WWAN component). The WWAN component 922 may facilitate similar connectivity to multiple networks (e.g., a UMTS network and an LTE network).

The network 956 may be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 924 is configured to connect to the network 956 via the WI-FI access points. Such connections may be secured via various encryption technologies including, but not limited to, WI-FI Protected Access (“WPA”), WPA2, Wired Equivalent Privacy (“WEP”), and the like.

The network 956 may be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 926 is configured to facilitate communications with other devices, such as peripherals, computers, or other computing devices via the WPAN.

The sensor components 908 include a magnetometer 928, an ambient light sensor 930, a proximity sensor 932, an accelerometer 934, a gyroscope 936, and a Global Positioning System sensor (“GPS sensor”) 938. It is contemplated that other sensors, such as, but not limited to, temperature sensors or shock detection sensors, also may be incorporated in the computing device architecture 900.

The I/O components 910 include a display 940, a touchscreen 942, a data I/O interface component (“data I/O”) 944, an audio I/O interface component (“audio I/O”) 946, a video I/O interface component (“video I/O”) 948, and a camera 950. In some configurations, the display 940 and the touchscreen 942 are combined. In some configurations two or more of the data I/O component 944, the audio I/O component 946, and the video I/O component 948 are combined. The I/O components 910 may include discrete processors configured to support the various interfaces described below or may include processing functionality built-in to the processor 902.

The illustrated power components 912 include one or more batteries 952, which can be connected to a battery gauge 954. The batteries 952 may be rechargeable or disposable. Rechargeable battery types include, but are not limited to, lithium polymer, lithium ion, nickel cadmium, and nickel metal hydride. Each of the batteries 952 may be made of one or more cells.

The power components 912 may also include a power connector, which may be combined with one or more of the aforementioned I/O components 910. The power components 912 may interface with an external power system or charging equipment via an I/O component.

Examples of Various Implementations

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The present disclosure is made in light of the following clauses:

Clause 1: A computer-implemented method for data verification on a blockchain, the method comprising: generating an entity data block on an entity data blockchain responsive to a data event, the entity data block having a corresponding class of service; submitting the entity data block to a cluster of verification nodes, each of the verification nodes having an associated class of service, for voting by the verification nodes on whether to verify the entity data block; receiving votes on whether to verify the entity data block from one or more of the verification nodes; weighting each received vote based on a relationship between the corresponding class of service of the entity data block and the class of service associated with the verification node that provided the vote to obtain a weighted vote for each received vote; calculating a verification score based on the weighted votes; determining whether the verification score exceeds a verification threshold; and validating the entity data block on the blockchain if the verification score exceeds the verification threshold.

Clause 2. The computer-implemented method of Clause 1, where: the corresponding class of service of the entity data block includes at least one of an educational class, a work history class, a skills class, a financial information class, a community service class, and a public record class; and the associated class of service for a verification node includes at least one of an educational institution class, an employer class, a certification body class, a financial institution class, a community service institution class, and a governmental entity class.

Clause 3. The computer-implemented method of Clause 2, where: the data event corresponds to an entity having an entity type, where the entity type comprises one of an educational institution, an employer entity, a certification body, a community service institution, and a governmental entity; and the class of service of the entity data block corresponds to the entity type of the entity to which the data event corresponds, where the class of service comprises one of the educational class, the work history class, the skills class, the community service class, and the public service class.

Clause 4. The computer-implemented method of Clause 2, where the step of weighting each received vote based on a relationship between the corresponding class of service of the entity data block and the class of service associated with the verification node that provided the vote to determine a weighted vote for each received vote includes: combining the weighting of each received vote based on the relationship between the corresponding class of service of the entity data block and the class of service associated with the verification node that provided the vote with a predetermined base weight of the verification node that provided the vote to determine the weighted vote for each received vote.

Clause 5. The computer-implemented method of Clause 1, where the method includes: submitting a candidate verification node to the cluster of verification nodes, the candidate verification node having an associated class of service, for voting by the verification nodes on whether to accept the candidate verification node to the cluster of verification nodes; receiving node acceptance votes on whether to accept the candidate verification node from one or more of the verification nodes of the cluster of verification nodes; weighting each received node acceptance vote based on a relationship between the class of service of the candidate verification node and the class of service associated with the verification node that provided the node acceptance vote to obtain a weighted node acceptance vote for each received node acceptance vote; calculating a node acceptance score based on the weighted node acceptance votes; determining whether the node acceptance score exceeds a node acceptance threshold; and adding the candidate verification node to the cluster of verification nodes if the node acceptance score exceeds the node acceptance threshold.

Clause 6. The computer-implemented method of Clause 5, where: the class of service for the candidate verification node and each of the cluster of verification nodes includes at least one of an educational institution class, an employer class, a certification body class, a financial institution class, a community service institution class, and a governmental entity class.

Clause 7. The computer-implemented method of Clause 6, where the step of weighting each received node acceptance vote based on a relationship between the class of service of the candidate verification node and the class of service associated with the verification node that provided the node acceptance vote to obtain a weighted node acceptance vote for each received node acceptance vote includes: combining the weighting of each received node acceptance vote based on the relationship between the class of service of the candidate verification node and the class of service associated with the verification node that provided the node acceptance vote with a predetermined base acceptance node weight of the verification node that provided the node acceptance vote to obtain the weighted node acceptance vote for each received node acceptance vote.

Clause 8. A system for data verification on a blockchain, the system comprising: one or more processors; and one or more memory devices in communication with the one or more processors, the memory devices having computer-readable instructions stored thereupon that, when executed by the processors, cause the processors to perform a method comprising: generating an entity data block on an entity data blockchain responsive to a data event, the entity data block having a corresponding class of service; submitting the entity data block to a cluster of verification nodes, each of the verification nodes having an associated class of service, for voting by the verification nodes on whether to verify the entity data block; receiving votes on whether to verify the entity data block from one or more of the verification nodes; weighting each received vote based on a relationship between the corresponding class of service of the entity data block and the class of service associated with the verification node that provided the vote to obtain a weighted vote for each received vote; calculating a verification score based on the weighted votes; determining whether the verification score exceeds a verification threshold; and validating the entity data block on the blockchain if the verification score exceeds the verification threshold.

Clause 9. The system of Clause 8, where: the corresponding class of service of the entity data block includes at least one of an educational class, a work history class, a skills class, a financial information class, a community service class, and a public record class; and the associated class of service for a verification node includes at least one of an educational institution class, an employer class, a certification body class, a financial institution class, a community service institution class, and a governmental entity class.

Clause 10. The system of Clause 9, where: the data event corresponds to an entity having an entity type, where the entity type comprises one of an educational institution, an employer entity, a certification body, a community service institution, and a governmental entity; and the class of service of the entity data block corresponds to the entity type of the entity to which the data event corresponds, where the class of service comprises one of the educational class, the work history class, the skills class, the community service class, and the public service class.

Clause 11. The system of Clause 9, where the operation of weighting each received vote based on a relationship between the corresponding class of service of the entity data block and the class of service associated with the verification node that provided the vote to determine a weighted vote for each received vote includes: combining the weighting of each received vote based on the relationship between the corresponding class of service of the entity data block and the class of service associated with the verification node that provided the vote with a predetermined base weight of the verification node that provided the vote to determine the weighted vote for each received vote.

Clause 12. The system of Clause 8, where the method includes: submitting a candidate verification node to the cluster of verification nodes, the candidate verification node having an associated class of service, for voting by the verification nodes on whether to accept the candidate verification node to the cluster of verification nodes; receiving node acceptance votes on whether to accept the candidate verification node from one or more of the verification nodes of the cluster of verification nodes; weighting each received node acceptance vote based on a relationship between the class of service of the candidate verification node and the class of service associated with the verification node that provided the node acceptance vote to obtain a weighted node acceptance vote for each received node acceptance vote; calculating a node acceptance score based on the weighted node acceptance votes; determining whether the node acceptance score exceeds a node acceptance threshold; and adding the candidate verification node to the cluster of verification nodes if the node acceptance score exceeds the node acceptance threshold.

Clause 13. The system of Clause 12, where: the class of service for the candidate verification node and each of the cluster of verification nodes includes at least one of an educational institution class, an employer class, a certification body class, a financial institution class, a community service institution class, and a governmental entity class.

Clause 14. The system of Clause 13, where the operation of weighting each received node acceptance vote based on a relationship between the class of service of the candidate verification node and the class of service associated with the verification node that provided the node acceptance vote to obtain a weighted node acceptance vote for each received node acceptance vote includes: combining the weighting of each received node acceptance vote based on the relationship between the class of service of the candidate verification node and the class of service associated with the verification node that provided the node acceptance vote with an acceptance node weight of the verification node that provided the node acceptance vote, where the acceptance node weight of the verification node that provided the node acceptance vote corresponds to a length of time that the verification node has been a member of the cluster of verification nodes, to obtain the weighted node acceptance vote for each received node acceptance vote.

Clause 15. One or more computer storage media having computer executable instructions stored thereon which, when executed by one or more processors, cause the processors to execute a method for managing a cluster of verification nodes for verification of data on a blockchain comprising: submitting a candidate verification node to the cluster of verification nodes, the candidate verification node having an associated class of service, for voting by the verification nodes on whether to accept the candidate verification node to the cluster of verification nodes; receiving node acceptance votes on whether to accept the candidate verification node from one or more of the verification nodes of the cluster of verification nodes; weighting each received node acceptance vote based on a relationship between the class of service of the candidate verification node and the class of service associated with the verification node that provided the node acceptance vote to obtain a weighted node acceptance vote for each received node acceptance vote; calculating a node acceptance score based on the weighted node acceptance votes; determining whether the node acceptance score exceeds a node acceptance threshold; and adding the candidate verification node to the cluster of verification nodes if the node acceptance score exceeds the node acceptance threshold.

Clause 16. The computer storage media of Clause 15, where: the class of service for the candidate verification node and each of the cluster of verification nodes includes at least one of an educational institution class, an employer class, a certification body class, a financial institution class, a community service institution class, and a governmental entity class.

Clause 17. The computer storage media of Clause 16, where the operation of weighting each received node acceptance vote based on a relationship between the class of service of the candidate verification node and the class of service associated with the verification node that provided the node acceptance vote to obtain a weighted node acceptance vote for each received node acceptance vote includes: combining the weighting of each received node acceptance vote based on the relationship between the class of service of the candidate verification node and the class of service associated with the verification node that provided the node acceptance vote with an acceptance node weight of the verification node that provided the node acceptance vote, where the acceptance node weight of the verification node that provided the node acceptance vote corresponds to a length of time that the verification node has been a member of the cluster of verification nodes, to obtain the weighted node acceptance vote for each received node acceptance vote.

Clause 18. The computer storage media of Clause 15, where the method includes: generating an entity data block on an entity data blockchain responsive to a data event, the entity data block having a corresponding class of service; submitting the entity data block to the cluster of verification nodes, each of the verification nodes having an associated class of service, for voting by the verification nodes on whether to verify the entity data block; receiving votes on whether to verify the entity data block from one or more of the verification nodes; weighting each received vote based on a relationship between the corresponding class of service of the entity data block and the class of service associated with the verification node that provided the vote to obtain a weighted vote for each received vote; calculating a verification score based on the weighted votes; determining whether the verification score exceeds a verification threshold; and validating the entity data block on the blockchain if the verification score exceeds the verification threshold.

Clause 19. The computer storage media of Clause 18, where: the corresponding class of service of the entity data block includes at least one of an educational class, a work history class, a skills class, a financial information class, a community service class, and a public record class; and the associated class of service for a verification node includes at least one of an educational institution class, an employer class, a certification body class, a financial institution class, a community service institution class, and a governmental entity class.

Clause 20. The system of Clause 19, where: the data event corresponds to an entity having an entity type, where the entity type comprises one of an educational institution, an employer entity, a certification body, a community service institution, and a governmental entity; and the class of service of the entity data block corresponds to the entity type of the entity to which the data event corresponds, where the class of service comprises one of the educational class, the work history class, the skills class, the community service class, and the public service class.

Although the subject matter presented herein has been described in language specific to computer structural features, methodological and transformative acts, specific computing machinery, and computer readable media, it is to be understood that the subject matter set forth in the appended claims is not necessarily limited to the specific features, acts, or media described herein. Rather, the specific features, acts and mediums are disclosed as example forms of implementing the claimed subject matter.

The subject matter described above is provided by way of illustration only and should not be construed as limiting. Various modifications and changes can be made to the subject matter described herein without following the example configurations and applications illustrated and described, and without departing from the scope of the present disclosure, which is set forth in the following claims.

What is claimed is:

1. A computer-implemented method for data verification on a blockchain, the method comprising:
generating an entity data block on an entity data blockchain responsive to a data event, the entity data block having a corresponding class of service;
submitting the entity data block to a cluster of verification nodes, each of the verification nodes having an associated class of service, for voting by the verification nodes on whether to verify the entity data block;
receiving votes on whether to verify the entity data block from one or more of the verification nodes;
weighting each received vote based on a relationship between the corresponding class of service of the entity data block and the class of service associated with the verification node that provided the vote to obtain a weighted vote for each received vote;
calculating a verification score based on the weighted votes;
determining whether the verification score exceeds a verification threshold; and
validating the entity data block on the blockchain if the verification score exceeds the verification threshold.

2. The computer-implemented method of claim 1, where:
the corresponding class of service of the entity data block includes at least one of an educational class, a work history class, a skills class, a financial information class, a community service class, and a public record class; and
the associated class of service for a verification node includes at least one of an educational institution class, an employer class, a certification body class, a financial institution class, a community service institution class, and a governmental entity class.

3. The computer-implemented method of claim 2, where:
the data event corresponds to an entity having an entity type, where the entity type comprises one of an educational institution, an employer entity, a certification body, a community service institution, and a governmental entity; and
the class of service of the entity data block corresponds to the entity type of the entity to which the data event corresponds, where the class of service comprises one of the educational class, the work history class, the skills class, the community service class, and the public service class.

4. The computer-implemented method of claim 2, where the step of weighting each received vote based on a relationship between the corresponding class of service of the entity data block and the class of service associated with the verification node that provided the vote to determine a weighted vote for each received vote includes:
combining the weighting of each received vote based on the relationship between the corresponding class of service of the entity data block and the class of service associated with the verification node that provided the vote with a predetermined base weight of the verification node that provided the vote to determine the weighted vote for each received vote.

5. The computer-implemented method of claim 1, where the method includes:
submitting a candidate verification node to the cluster of verification nodes, the candidate verification node having an associated class of service, for voting by the verification nodes on whether to accept the candidate verification node to the cluster of verification nodes;
receiving node acceptance votes on whether to accept the candidate verification node from one or more of the verification nodes of the cluster of verification nodes;
weighting each received node acceptance vote based on a relationship between the class of service of the candidate verification node and the class of service associated with the verification node that provided the node acceptance vote to obtain a weighted node acceptance vote for each received node acceptance vote;
calculating a node acceptance score based on the weighted node acceptance votes;
determining whether the node acceptance score exceeds a node acceptance threshold; and
adding the candidate verification node to the cluster of verification nodes if the node acceptance score exceeds the node acceptance threshold.

6. The computer-implemented method of claim 5, where:
the class of service for the candidate verification node and each of the cluster of verification nodes includes at least one of an educational institution class, an employer class, a certification body class, a financial institution class, a community service institution class, and a governmental entity class.

7. The computer-implemented method of claim 6, where the step of weighting each received node acceptance vote based on a relationship between the class of service of the candidate verification node and the class of service associated with the verification node that provided the node acceptance vote to obtain a weighted node acceptance vote for each received node acceptance vote includes:
combining the weighting of each received node acceptance vote based on the relationship between the class of service of the candidate verification node and the class of service associated with the verification node that provided the node acceptance vote with a predetermined base acceptance node weight of the verification node that provided the node acceptance vote to obtain the weighted node acceptance vote for each received node acceptance vote.

8. A system for data verification on a blockchain, the system comprising:
one or more processors; and
one or more memory devices in communication with the one or more processors, the memory devices having computer-readable instructions stored thereupon that, when executed by the processors, cause the processors to perform a method comprising:
generating an entity data block on an entity data blockchain responsive to a data event, the entity data block having a corresponding class of service;
submitting the entity data block to a cluster of verification nodes, each of the verification nodes having an associated class of service, for voting by the verification nodes on whether to verify the entity data block;
receiving votes on whether to verify the entity data block from one or more of the verification nodes;
weighting each received vote based on a relationship between the corresponding class of service of the entity data block and the class of service associated with the verification node that provided the vote to obtain a weighted vote for each received vote;
calculating a verification score based on the weighted votes;
determining whether the verification score exceeds a verification threshold; and
validating the entity data block on the blockchain if the verification score exceeds the verification threshold.

9. The system of claim 8, where:
the corresponding class of service of the entity data block includes at least one of an educational class, a work history class, a skills class, a financial information class, a community service class, and a public record class; and
the associated class of service for a verification node includes at least one of an educational institution class, an employer class, a certification body class, a financial institution class, a community service institution class, and a governmental entity class.

10. The system of claim 9, where:
the data event corresponds to an entity having an entity type, where the entity type comprises one of an educational institution, an employer entity, a certification body, a community service institution, and a governmental entity; and
the class of service of the entity data block corresponds to the entity type of the entity to which the data event corresponds, where the class of service comprises one of the educational class, the work history class, the skills class, the community service class, and the public service class.

11. The system of claim 9, where the operation of weighting each received vote based on a relationship between the corresponding class of service of the entity data block and the class of service associated with the verification node that provided the vote to determine a weighted vote for each received vote includes:
combining the weighting of each received vote based on the relationship between the corresponding class of service of the entity data block and the class of service associated with the verification node that provided the vote with a predetermined base weight of the verification node that provided the vote to determine the weighted vote for each received vote.

12. The system of claim 8, where the method includes:
submitting a candidate verification node to the cluster of verification nodes, the candidate verification node having an associated class of service, for voting by the verification nodes on whether to accept the candidate verification node to the cluster of verification nodes;
receiving node acceptance votes on whether to accept the candidate verification node from one or more of the verification nodes of the cluster of verification nodes;
weighting each received node acceptance vote based on a relationship between the class of service of the candidate verification node and the class of service associated with the verification node that provided the node acceptance vote to obtain a weighted node acceptance vote for each received node acceptance vote;
calculating a node acceptance score based on the weighted node acceptance votes;
determining whether the node acceptance score exceeds a node acceptance threshold; and
adding the candidate verification node to the cluster of verification nodes if the node acceptance score exceeds the node acceptance threshold.

13. The system of claim 12, where:
the class of service for the candidate verification node and each of the cluster of verification nodes includes at least one of an educational institution class, an employer class, a certification body class, a financial institution class, a community service institution class, and a governmental entity class.

14. The system of claim 13, where the operation of weighting each received node acceptance vote based on a relationship between the class of service of the candidate verification node and the class of service associated with the verification node that provided the node acceptance vote to obtain a weighted node acceptance vote for each received node acceptance vote includes:
combining the weighting of each received node acceptance vote based on the relationship between the class of service of the candidate verification node and the class of service associated with the verification node that provided the node acceptance vote with an acceptance node weight of the verification node that provided the node acceptance vote, where the acceptance node weight of the verification node that provided the node acceptance vote corresponds to a length of time that the verification node has been a member of the cluster of verification nodes, to obtain the weighted node acceptance vote for each received node acceptance vote.

15. One or more computer storage media having computer executable instructions stored thereon which, when executed by one or more processors, cause the processors to execute a method for managing a cluster of verification nodes for verification of data on a blockchain comprising:
submitting a candidate verification node to the cluster of verification nodes, the candidate verification node having an associated class of service, for voting by the verification nodes on whether to accept the candidate verification node to the cluster of verification nodes;
receiving node acceptance votes on whether to accept the candidate verification node from one or more of the verification nodes of the cluster of verification nodes;
weighting each received node acceptance vote based on a relationship between the class of service of the candidate verification node and the class of service associated with the verification node that provided the node acceptance vote to obtain a weighted node acceptance vote for each received node acceptance vote;
calculating a node acceptance score based on the weighted node acceptance votes;
determining whether the node acceptance score exceeds a node acceptance threshold; and
adding the candidate verification node to the cluster of verification nodes if the node acceptance score exceeds the node acceptance threshold.

16. The computer storage media of claim 15, where:
the class of service for the candidate verification node and each of the cluster of verification nodes includes at least one of an educational institution class, an employer class, a certification body class, a financial institution class, a community service institution class, and a governmental entity class.

17. The computer storage media of claim 16, where the operation of weighting each received node acceptance vote based on a relationship between the class of service of the candidate verification node and the class of service associated with the verification node that provided the node acceptance vote to obtain a weighted node acceptance vote for each received node acceptance vote includes:
combining the weighting of each received node acceptance vote based on the relationship between the class of service of the candidate verification node and the class of service associated with the verification node that provided the node acceptance vote with an acceptance node weight of the verification node that provided the node acceptance vote, where the acceptance node weight of the verification node that provided the node acceptance vote corresponds to a length of time that the verification node has been a member of the cluster of verification nodes, to obtain the weighted node acceptance vote for each received node acceptance vote.

18. The computer storage media of claim 15, where the method includes:
generating an entity data block on an entity data blockchain responsive to a data event, the entity data block having a corresponding class of service;
submitting the entity data block to the cluster of verification nodes, each of the verification nodes having an associated class of service, for voting by the verification nodes on whether to verify the entity data block;
receiving votes on whether to verify the entity data block from one or more of the verification nodes;
weighting each received vote based on a relationship between the corresponding class of service of the entity data block and the class of service associated with the verification node that provided the vote to obtain a weighted vote for each received vote;
calculating a verification score based on the weighted votes;
determining whether the verification score exceeds a verification threshold; and
validating the entity data block on the blockchain if the verification score exceeds the verification threshold.

19. The computer storage media of claim 18, where:
the corresponding class of service of the entity data block includes at least one of an educational class, a work history class, a skills class, a financial information class, a community service class, and a public record class; and
the associated class of service for a verification node includes at least one of an educational institution class, an employer class, a certification body class, a financial institution class, a community service institution class, and a governmental entity class.

20. The system of claim 19, where:
the data event corresponds to an entity having an entity type, where the entity type comprises one of an educational institution, an employer entity, a certification body, a community service institution, and a governmental entity; and
the class of service of the entity data block corresponds to the entity type of the entity to which the data event corresponds, where the class of service comprises one of the educational class, the work history class, the skills class, the community service class, and the public service class.
